(19) United States
(12) Patent Application Publication
(10) Pub. No.: US 2010/0260258 A1
(43) Pub. Date: Oct. 14, 2010

(54) IMAGE CODING DEVICE, CODING RATE CONVERSION DEVICE, AUDIO VIDEO STREAM RECORDING DEVICE, NETWORK DISTRIBUTION SYSTEM, COEFFICIENT CONVERSION DEVICE, INTEGRATED CIRCUIT, AND IMAGE CODING METHOD

(76) Inventors: Kyoko Ueda, Osaka (JP); Hiroshi Ikeda, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/747,250

(22) PCT Filed: Dec. 10, 2008
(86) PCT No.: PCT/JP2008/003699

§ 371 Date: Jun. 10, 2010

(30) Foreign Application Priority Data
Dec. 13, 2007 (JP) 2007-321822

(51) Int. Cl. H04N 7/30; G06K 9/00

(52) U.S. Cl. 375/240.03; 382/251; 375/240.18; 375/E07.226

(57) ABSTRACT

An image coding device (301) in an aspect of the present invention includes: a quantization unit (304) which quantizes an orthogonal transform coefficient set (217) obtained by orthogonally transforming image data (310), so as to generate a quantized coefficient set (110) that corresponds to one coded block unit; a coefficient sequence extraction unit (101) which extracts a first coefficient sequence (112) that is a part of the quantized coefficient set (110); a coefficient non-zeroing unit (102) which converts at least one of zero coefficients included in the first coefficient sequence (112) into a nonzero coefficient, so as to generate a second coefficient sequence (113) including all coefficients resulting from the conversion; a coefficient sequence selection unit (106) which selects one of the first coefficient sequence (112) and the second coefficient sequence (113), the selected one having a smaller amount of codes when coded; and a variable-length coding unit (306) which performs variable-length coding on the first coefficient sequence (112) or the second coefficient sequence (113) selected by the coefficient sequence selection unit (106), so as to generate coded image data (311).

### TECHNICAL FIELD

The present invention relates to image coding devices, coding rate conversion devices, audio video stream recording devices, network distribution systems, coefficient conversion devices, integrated circuits, and image coding methods. In particular, the present invention relates to an image coding device that performs variable-length coding on a quantized coefficient having been orthogonally transformed and quantized.

### BACKGROUND ART

In recent years, MPEG-2 (Moving Picture Experts Group 2) and H.264/AVC (Advanced Video Coding) that realize high compression have been adopted as image coding techniques used in recording media, such as DVDs, and in digital broadcast.

According to these image coding techniques, motion compensation, orthogonal transform, quantization, and variable-length coding are performed on image data and, as a result, coded image data is generated.

As examples of such image coding techniques, the coding procedures in the cases of MPEG-2 and H.264/AVC are explained as follows.

A coding procedure according to MPEG-2 is first explained.

FIG. 1 is a diagram showing a structure of image data 901 in MPEG-2 format. The image data 901 includes a plurality of pictures 902. One picture 902 includes at least one slice 903. One slice 903 includes at least one macroblock 904.

One macroblock 904 has six blocks in total including four luminance blocks 905 and two chrominance blocks 906 in the standard format (represented by 4:2:0). The ratio between the number of luminance blocks and the number of the chrominance blocks included in one macroblock 904 is determined based on the feature of human vision that the human eye is more sensitive to luminance than to chrominance. These six blocks are coded sequentially in the following order: a luminance block Y1, a luminance block Y2, a luminance block Y3, a luminance block Y4, a chrominance block Cb (blue component), and a chrominance Cr (red component).

Motion compensation, DCT (Discreate Cosine Transform) (i.e., orthogonal transform), and quantization are performed on each of the blocks, so that the blocks are converted into a quantized coefficient set 907. After this, a plurality of coefficients 908 included in the quantized coefficient set 907 are sequentially coded in either a zigzag scanning order or an alternate scanning order.

FIGS. 2A and 2B are diagrams each showing a coding order in the case of zigzag scanning, whereas FIGS. 2C and 2D are diagrams each showing a coding order in the case of alternate scanning. Note that the coefficients are coded in ascending numeric order in each of FIGS. 2A and 2C, and that the coefficients are coded in the order shown by the arrow in each of FIGS. 2B and 2D.

The quantized coefficient set 907 is coded, based on: “level” which is a value of a nonzero coefficient (that is, a coefficient whose value is other than zero); and “run” indicating the number of consecutive zero coefficients (that is, coefficients whose values are zero) that precede the present nonzero coefficient. After the last nonzero coefficient, an EOB (End of Block) is coded. Note that coding of the zero coefficients that follow the last nonzero coefficient is omitted.

FIG. 3 is a diagram showing a part of a coding table 910 that shows a code 913 corresponding to a combination of a run 911 and a level 912. In the coding table 910 shown in FIG. 3, a short length code 913 is assigned to a combination of the run 911 and the level 912 having a high probability of occurrence.

A fixed length code having 24 bits in total is assigned to a combination of the run 911 and the level 912 having a low probability of occurrence. This fixed length code includes an Escape code (6 bits), the run 911 represented by 6 bits that follows this Escape code, and the level 912 represented by 12 bits.

It should be noted that, in FIG. 3, “s” included in the code 913 becomes “0” when the value of the level 912 is positive, and becomes “1” when the value of the level 912 is negative. Also note that generating a block including only an EOB is not allowed.

Specific examples are explained as follows. FIG. 4 is a diagram showing a case where the zigzag scanning is employed for the quantized coefficient set 907 shown in FIG. 1. The diagram shows: a combination of the run 911 and the level 912; the code 913 corresponding to the combination; and a number of bits 914 of the code 913. The coefficients of the quantized coefficient set 907 shown in FIG. 1 are sequentially coded in the following order: “6, 3, 0, 0, 0, 5, and −1”. The rest of the coefficients are all zero. Accordingly, the quantized coefficient set 907 shown in FIG. 1 is converted into the combinations of the run 911 and the level 912 shown in FIG. 4. In this case, as shown in FIG. 4, the number of bits 914 of the codes 913 is 44 bits in total.

Next, a coding procedure according to H.264/AVC is explained.

It should be noted that since a picture structure and a block coding procedure of H.264/AVC are approximately the same as those of MPEG-2 and, therefore, the explanation is omitted.

FIG. 5 is a diagram showing syntax of variable-length decoding processing performed according to H.264/AVC. In the case of H.264/AVC, the quantized coefficient set 907 is coded using: the number of nonzero coefficients in a block (TotalCoeff); the number of last consecutive coefficients in the block whose absolute values are 1 (TrailingOnes); each sign of the last consecutive coefficients in the block whose absolute values are 1 (Trailing_ones_sign_flag); values (levels) of the nonzero coefficients included in the block, except for the last consecutive coefficients in the block whose absolute values are 1 and the number of which is indicated by TrailingOnes; the number of zero coefficients that precede the last nonzero coefficient in the block (total_zeros); and each number of consecutive zero coefficients immediately before each of the nonzero coefficients included in the block (run_before).

FIG. 6 is a diagram showing a part of a coding table 920 that shows a code 923 corresponding to a combination of a TotalCoeff 922 and a TrailingOnes 921. The TotalCoeff 922 and the TrailingOnes 921 are coded using the coding table 920 shown in FIG. 6. The TrailingOnes 921 takes on values from 0 to 3. Even in the case of four consecutive coefficients whose absolute values are 1, the TrailingOnces 921 takes on 3.

Moreover, the number of Trailing_ones_sign_flag is equal to the value representing TrailingOnes. The Trailing_ones_sign_flag becomes 0 when the coefficient whose absolute value is 1 has a positive value, and becomes 1 when the coefficient whose absolute value is 1 has a negative value.

The level 931 is coded in reverse scanning order using a suffixLength 932. When the TotalCoeff 922 is 11 or larger and the TrailingOnes 921 is below 3, an initial value of this suffixLength 932 is 1. Otherwise, the initial value is 0. When the sufficLength 932 is 0 after each of the levels 931 is coded, 1 is added to this suffixLength 932. Moreover, when the absolute value of the coded level 931 is larger than “3<<(suffixLength−1)” and the suffixLength 932 is below 6, 1 is added to the suffixLength 932. The suffixLength 932 updated in this way is used for coding a next level 931.

FIG. 7 is a diagram showing a part of a coding table 930 that shows a code 933 corresponding to a combination of the level 931 and the suffixLength 932. This coding table 930 can be derived from the decoding processing shown in FIG. 5.

The level 931 is coded using the coding table 930 and the suffixLength 932 shown in FIG. 7. Here, suppose that the TrailingOnes 921 is below 3 and the coding is to be performed on the first level 931 in the block. In this case, the code 933 in the coding table 930 that corresponds to the level 931 having a value 1 less than the absolute value of this first level 931 is referenced. This is because, in the case where the TrailingOnes 921 is below 3, the absolute value of the first level 931 in the block is definitely larger than 1.

FIG. 8 is a diagram showing a part of a coding table 940 that shows a code 943 corresponding to a combination of a total_zeros 941 and a TotalCoeff 922. The total_zeros 941 is coded using the coding table 940 shown in FIG. 8.

FIG. 9 is a diagram showing a part of a coding table 950 that shows a code 953 corresponding to a combination of a run_before 927 and a zerosLeft 928. The run_before 927 is coded using the coding table 950 shown in FIG. 9. Note that an initial value of the zerosLeft 928 is represented by the total_zeros 941. Whenever the run_before 927 is coded, the value of this run_before 927 is subtracted from the zerosLeft 928. Then, the reduced zerosLeft 928 is used for coding a next run_before 927.

Specific examples are explained as follows. FIG. 10 is a diagram showing pre-coded data 961, a code 962, and a number of bits 963 in the case where the quantized coefficient set 907 shown in FIG. 1 is coded. As shown in FIG. 10, the number of bits 963 of the codes 962 is 30 bits in total.

In this way, since each nonzero coefficient is coded in the variable-length coding according to MPEG-2 and H.264/AVC, the number of codes is equal to the number of nonzero coefficients. On this account, when the number of nonzero coefficients is less, the number of codes is less and thus the amount of codes in a block tends to decrease. On the basis of this principle, Patent Reference 1 discloses a bandwidth-scalable video transcoder that increases or decreases a value of a nonzero coefficient so that the number of nonzero coefficients becomes small. To be more specific, the video transcoder disclosed in Patent Reference 1 sets an output level at 0 with respect to a certain threshold (E) and an input level (L) when 0 is included in a range from L−E to L+E. When 0 is not included, the video transcoder sets the output level at an integer such that a code length becomes the shortest within this range.

However, there is a case where the amount of codes is smaller when the number of nonzero coefficients is larger.

FIGS. 11A and 11B are diagrams each showing an example of the quantized coefficient set and the amount of codes. Here, note that the coefficients are coded in zigzag scanning order using the coding table 910 shown in FIG. 3. A quantized coefficient set 970 shown in FIG. 11A includes two nonzero coefficients. The coefficients of the quantized coefficient set 970 are coded in the following order: (run=0, level=3), (run=4, level=5), and the EOB. The amount of codes is 32 bits in total. Meanwhile, a quantized coefficient set 971 shown in FIG. 11B includes three nonzero coefficients. The coefficients of the quantized coefficient set 971 are coded in the following order: (run=0, level=3), (run=3, level=1), (run=0, level=5), and the FOB. The amount of codes is 23 bits in total.

In this way, the amount of codes is less in the case of the quantized coefficient set 971 having a larger number of nonzero coefficients than the case of the quantized coefficient set 970 having a smaller number of nonzero coefficients. This is because although the number of nonzero coefficients in the quantized coefficient set 970 is smaller, the code length of the second coding target data (run, level)=(4, 5) in the quantized coefficient set 970 is long.

More specifically, there may be a case where setting a nonzero coefficient at 0 causes an increase in the amount of codes instead.

To address this, Patent Reference 2 discloses a transcoder that converts a nonzero coefficient into a zero coefficient and, when this conversion causes an increase in the amount of codes, converts the zero coefficient resulting from the conversion back into the original nonzero coefficient or the like.
Patent Reference 1: Japanese Unexamined Patent Application Publication No. 2003-87793
Patent Reference 2: Japanese Patent Publication No. 3856292

### DISCLOSURE OF INVENTION

### Problems that Invention is to Solve

However, the transcoder disclosed in Patent Reference 2 determines whether or not the amount of codes increases, for each coded block. For this reason, the circuit size thus increases, causing a problem that implementation may become complicated.

The present invention is conceived in view of the stated problem, and has an object to provide an image coding device, a coding rate conversion device, an audio video stream recording device, a network distribution system, a coefficient conversion device, an integrated circuit, and an image coding method capable of reducing the amount of codes and the circuit size.

### Means to Solve the Problems

In order to achieve the above object, the image coding device according to an aspect of the present invention is an image coding device including: a quantization unit which quantizes an orthogonal transform coefficient set obtained by orthogonally transforming image data, so as to generate a quantized coefficient set that corresponds to one coded block unit; a coefficient sequence extraction unit which extracts a first coefficient sequence that is a part of the quantized coefficient set; a coefficient non-zeroing unit which converts at least one of zero coefficients included in the first coefficient sequence into a nonzero coefficient, so as to generate a second coefficient sequence including all coefficients resulting from the conversion; a coefficient sequence selection unit which selects one of the first coefficient sequence and the second coefficient sequence, the selected one having a smaller amount of codes when coded; and a variable-length coding unit which performs variable-length coding on the one of the first coefficient sequence and the second coefficient sequence selected by the coefficient sequence selection unit, so as to generate coded image data.

With this configuration, the image coding device according to the aspect of the present invention can reduce the amount of codes for the coded image data by converting a zero coefficient into a nonzero coefficient. Moreover, the image coding device according to the aspect of the present invention determines whether or not the amount of codes is reduced by converting the zero coefficient into the nonzero coefficient for the first coefficient sequence included in the quantized coefficient set. On this account, as compared to the case where the determination as to whether or not the amount of codes is reduced is made for all the coefficients included in the quantized coefficient set, the circuit size can be reduced. Accordingly, the image coding device in the aspect of the present invention can be easily realized.

Moreover, the coefficient sequence extraction unit may sequentially extract a plurality of first coefficient sequences from the quantized coefficient set; the coefficient non-zeroing unit may generate the second coefficient sequence for each of the first coefficient sequences extracted by the coefficient sequence extraction unit; and the coefficient sequence selection unit may make a selection, for each of the first coefficient sequences, between the first coefficient sequence and the second coefficient sequence corresponding to the first coefficient sequence, the selected first or second coefficient sequence having a smaller amount of codes when coded.

With this configuration, the image coding device in the aspect of the present invention determines whether or not the amount of codes is reduced by converting the zero coefficient into the nonzero coefficient, for each of the first coefficient sequences included in the quantized coefficient set. Thus, the circuit size can be reduced.

The coefficient sequence extraction unit may extract, as the first coefficient sequence, consecutive zero coefficients and one nonzero coefficient that follows the consecutive zero coefficients, from a coefficient sequence in which all coefficients included in the quantized coefficient set are arranged in a scanning order.

The coefficient non-zeroing unit may convert a zero coefficient out of the zero coefficients included in the first coefficient sequence into a nonzero coefficient, the zero coefficient having been a nonzero coefficient before the quantization.

With this configuration, the image coding device in the aspect of the present invention can more prevent image degradation by converting a coefficient whose value was nonzero before the quantization into a nonzero coefficient, than the case where a coefficient whose value was zero before the quantization is converted into a nonzero coefficient.

The coefficient non-zeroing unit may convert the zero coefficient into: 1 when the zero coefficient that is to be converted into the nonzero coefficient is a positive-value coefficient before the quantization; and −1 when the zero coefficient that is to be converted into the nonzero coefficient is a negative-value coefficient before the quantization.

With this configuration, the image coding device in the aspect of the present invention can reduce the amount of codes for the second coefficient sequence as well as preventing image degradation.

The coefficient non-zeroing unit may convert a last zero coefficient included in the first coefficient sequence into a nonzero coefficient, so as to generate the second coefficient sequence.

With this configuration, when the values of both the level and the run are large, the image coding device in the aspect of the present invention can set the run corresponding to the large level at “0”, thereby effectively reducing the amount of codes.

The coefficient non-zeroing unit may convert at least one of the zero coefficients included in the first coefficient sequence into 1, so as to generate the second coefficient sequence.

With this configuration, the image coding device in the aspect of the present invention can reduce the amount of codes for the second coefficient sequence as well as preventing image degradation that may be caused by the conversion of the zero coefficient into the nonzero coefficient.

The coefficient non-zeroing unit may convert at least one of the zero coefficients included in the first coefficient sequence into −1, so as to generate the second coefficient sequence.

With this configuration, the image coding device in the aspect of the present invention can reduce the amount of codes for the second coefficient sequence as well as preventing image degradation that may be caused by the conversion of the zero coefficient into the nonzero coefficient.

The coefficient sequence extraction unit may extract, from a coefficient sequence in which all coefficients included in the quantized coefficient set are arranged in a scanning order, a sequence from a beginning to a last nonzero coefficient of the coefficient sequence as the first coefficient sequence.

The audio video stream recording device according to an aspect of the present invention is an audio video stream recording device including: an image coding unit which codes image data to generate coded image data; a multiplexing unit which multiplexes the coded image data, audio data, and system data so as to generate an audio video stream; and a control unit which records the audio video stream into a recording medium, wherein the image coding unit includes: an orthogonal transform unit which orthogonally transforms the image data so as to generate an orthogonal transform coefficient set; a quantization unit which quantizes the orthogonal transform coefficient set so as to generate a quantized coefficient set that corresponds to one coded block unit; a coefficient sequence extraction unit which extracts a first coefficient sequence that is a part of the quantized coefficient set; a coefficient non-zeroing unit which converts at least one of zero coefficients included in the first coefficient sequence into a nonzero coefficient, so as to generate a second coefficient sequence including all coefficients resulting from the conversion; a coefficient sequence selection unit which selects one of the first coefficient sequence and the second coefficient sequence, the selected one having a smaller amount of codes when coded; and a variable-length coding unit which performs variable-length coding on the one of the first coefficient sequence and the second coefficient sequence selected by the coefficient sequence selection unit, so as to generate coded image data.

With this configuration, the audio video stream recording device in the aspect of the present invention can reduce the amount of codes for the coded image data by converting a zero coefficient into a nonzero coefficient. Moreover, the audio video stream recording device according to the aspect of the present invention determines whether or not the amount of codes is reduced by converting the zero coefficient into the nonzero coefficient for the first coefficient sequence included in the quantized coefficient set. On this account, as compared to the case where the determination as to whether or not the amount of codes is reduced is made for all the coefficients included in the quantized coefficient set, the circuit size can be reduced. Accordingly, the audio video stream recording device in the aspect of the present invention can be easily realized.

The network distribution system according to an aspect of the present invention is a network system including an audio video stream receiving device and an audio video stream sending device that sends an audio video stream to the audio video stream receiving device via a network, wherein the audio video stream sending device includes: an image coding unit which codes image data to generate coded image data; a multiplexing unit which multiplexes the coded image data, audio data, and system data so as to generate an audio video stream; and a sending control unit which sends the audio video stream generated by the multiplexing unit to the audio video stream receiving device via the network, the image coding unit has: an orthogonal transform unit which orthogonally transforms the image data so as to generate an orthogonal transform coefficient set; a quantization unit which quantizes the orthogonal transform coefficient set so as to generate a quantized coefficient set that corresponds to one coded block unit; a coefficient sequence extraction unit which extracts a first coefficient sequence which is a part of the quantized coefficient set; a coefficient non-zeroing unit which converts at least one of zero coefficients included in the first coefficient sequence into a nonzero coefficient, so as to generate a second coefficient sequence including all coefficients resulting from the conversion; a coefficient sequence selection unit which selects one of the first coefficient sequence and the second coefficient sequence, the selected one having a smaller amount of codes when coded; and a variable-length coding unit which performs variable-length coding on the one of the first coefficient sequence and the second coefficient sequence selected by the coefficient sequence selection unit, so as to generate coded image data, and the audio video stream receiving device includes: a receiving control unit which receives the audio video stream sent from the sending control unit; and an audio video reproduction unit which reproduces the audio video stream received by the receiving control unit.

With this configuration, the audio video stream sending device in the aspect of the present invention can reduce the amount of codes for the coded image data by converting a zero coefficient into a nonzero coefficient. Moreover, the audio video stream sending device according to the aspect of the present invention determines whether or not the amount of codes is reduced by converting the zero coefficient into the nonzero coefficient for the first coefficient sequence included in the quantized coefficient set. On this account, as compared to the case where the determination as to whether or not the amount of codes is reduced is made for all the coefficients included in the quantized coefficient set, the circuit size can be reduced. Accordingly, the audio video stream sending device in the aspect of the present invention can be easily realized.

The coding rate conversion device according to an aspect of the present invention is a coding rate conversion device that converts a coding rate of first coded image data on which variable-length coding has been performed after quantization with a first quantization step, so as to generate second coded image data, the coding rate conversion device including: a variable-length decoding unit which performs variable-length decoding on the first coded image data so as to generate a first quantized coefficient set quantized with the first quantization step; an inverse quantization unit which inversely quantizes the first quantized coefficient set with the first quantization step so as to generate an orthogonal transform coefficient set; a requantization unit which requantizes the orthogonal transform coefficient set with a second quantization step larger in step size than the first quantization step, so as to generate a second quantized coefficient set that corresponds to one coded block unit; a coefficient sequence extraction unit which extracts a first coefficient sequence included in the second quantized coefficient set; a coefficient non-zeroing unit which converts at least one of zero coefficients included in the first coefficient sequence into a nonzero coefficient, so as to generate a second coefficient sequence including all coefficients resulting from the conversion; a coefficient sequence selection unit which selects one of the first coefficient sequence and the second coefficient sequence, the selected one having a smaller amount of codes when coded; and a variable-length coding unit which performs variable-length coding on the one of the first coefficient sequence and the second coefficient sequence selected by the coefficient sequence selection unit, so as to generate coded image data.

With this configuration, the coding rate conversion device in the aspect of the present invention can reduce the amount of codes for the second coded image data by converting a zero coefficient into a nonzero coefficient. Moreover, the coding rate conversion device according to the aspect of the present invention determines whether or not the amount of codes is reduced by converting the zero coefficient into the nonzero coefficient for the first coefficient sequence included in the quantized coefficient set. On this account, as compared to the case where the determination as to whether or not the amount of codes is reduced is made for all the coefficients included in the quantized coefficient set, the circuit size can be reduced. Accordingly, the coding rate conversion device in the aspect of the present invention can be easily realized.

The audio video stream recording device according to an aspect of the present invention is an audio video stream recording device including: a demultiplexing unit which divides a first audio video stream into first coded image data, audio data, and system data; a coding rate conversion unit which converts a coding rate of the first coded image data to generate second coded image data; a multiplexing unit which multiplexes the second coded image data, the audio data, and the system data so as to generate second audio video stream; and a control unit which records the second audio video stream into a recording medium, wherein the coding rate conversion unit includes: a variable-length decoding unit which performs variable-length decoding on the first coded image data so as to generate a first quantized coefficient set quantized with the first quantization step; an inverse quantization unit which inversely quantizes the first quantized coefficient set with the first quantization step so as to generate an orthogonal transform coefficient set; a requantization unit which requantizes the orthogonal transform coefficient set with a second quantization step larger in step size than the first quantization step, so as to generate a second quantized coefficient set that corresponds to one coded block unit; a coefficient sequence extraction unit which extracts a first coefficient sequence included in the second quantized coefficient set; a coefficient non-zeroing unit which converts at least one of zero coefficients included in the first coefficient sequence into a nonzero coefficient, so as to generate a second coefficient sequence including all coefficients resulting from the conversion; a coefficient sequence selection unit which selects one of the first coefficient sequence and the second coefficient sequence, the selected one having a smaller amount of codes when coded; and a variable-length coding unit which performs variable-length coding on the one of the first coefficient sequence and the second coefficient sequence selected by the coefficient sequence selection unit, so as to generate coded image data.

With this configuration, the audio video stream recording device in the aspect of the present invention can reduce the amount of codes for the second coded image data by converting a zero coefficient into a nonzero coefficient. Moreover, the audio video stream recording device according to the aspect of the present invention determines whether or not the amount of codes is reduced by converting the zero coefficient into the nonzero coefficient for the first coefficient sequence included in the quantized coefficient set. On this account, as compared to the case where the determination as to whether or not the amount of codes is reduced is made for all the coefficients included in the quantized coefficient set, the circuit size can be reduced. Accordingly, the audio video stream recording device in the aspect of the present invention can be easily realized.

The network distribution system according to an aspect of the present invention is a network system including an audio video stream receiving device and an audio video stream sending device that sends an audio video stream to the audio video stream receiving device via a network, wherein the audio video sending device includes: a demultiplexing unit which divides a first audio video stream into first coded image data, audio data, and system data;

a coding rate conversion unit which converts a coding rate of the first coded image data to generate second coded image data; a multiplexing unit which multiplexes the second coded image data, the audio data, and the system data so as to generate second audio video stream; and a sending control unit which sends the second audio video stream to the audio video stream receiving device via the network, wherein the coding rate conversion unit includes: a variable-length decoding unit which performs variable-length decoding on the first coded image data so as to generate a first quantized coefficient set quantized with the first quantization step; an inverse quantization unit which inversely quantizes the first quantized coefficient set with the first quantization step so as to generate an orthogonal transform coefficient set; a requantization unit which requantizes the orthogonal transform coefficient set with a second quantization step larger in step size than the first quantization step, so as to generate a second quantized coefficient set that corresponds to one coded block unit; a coefficient sequence extraction unit which extracts a first coefficient sequence included in the second quantized coefficient set; a coefficient non-zeroing unit which converts at least one of zero coefficients included in the first coefficient sequence into a nonzero coefficient, so as to generate a second coefficient sequence including all coefficients resulting from the conversion; a coefficient sequence selection unit which selects one of the first coefficient sequence and the second coefficient sequence, the selected one having a smaller amount of codes when coded; and a variable-length coding unit which performs variable-length coding on the one of the first coefficient sequence and the second coefficient sequence selected by the coefficient sequence selection unit, so as to generate coded image data, the audio video stream receiving device includes: a receiving control unit which receives the audio video stream sent from the sending control unit; and an audio video reproduction unit which reproduces the audio video stream received by the receiving control unit.

With this configuration, the audio video stream sending device in the aspect of the present invention can reduce the amount of codes for the second coded image data by converting a zero coefficient into a nonzero coefficient. Moreover, the audio video stream sending device according to the aspect of the present invention determines whether or not the amount of codes is reduced by converting the zero coefficient into the nonzero coefficient for the first coefficient sequence included in the quantized coefficient set. On this account, as compared to the case where the determination as to whether or not the amount of codes is reduced is made for all the coefficients included in the quantized coefficient set, the circuit size can be reduced. Accordingly, the audio video stream sending device in the aspect of the present invention can be easily realized.

The coefficient conversion device according to an aspect of the present invention is a coefficient conversion device which converts a quantized coefficient set corresponding to one coded block unit obtained by orthogonally transforming and quantizing image data, into a quantized coefficient set on which variable-length coding is to be performed, the coefficient conversion device including: a coefficient sequence extraction unit which extracts a first coefficient sequence which is a part of the quantized coefficient set; a coefficient non-zeroing unit which converts at least one of zero coefficients included in the first coefficient sequence into a nonzero coefficient, so as to generate a second coefficient sequence including all coefficients resulting from the conversion; and a coefficient sequence selection unit which selects one of the first coefficient sequence and the second coefficient sequence as the quantized coefficient set on which variable-length coding is to be performed, the selected one having a smaller amount of codes when coded.

With this configuration, the coefficient conversion device in the aspect of the present invention can generate the quantized coefficient set whose amount of codes is small when coded, by converting the zero coefficient into the nonzero coefficient. Moreover, the coefficient conversion device according to the aspect of the present invention determines whether or not the amount of codes is reduced by converting the zero coefficient into the nonzero coefficient for the first coefficient sequence included in the quantized coefficient set. On this account, as compared to the case where the determination as to whether or not the amount of codes is reduced is made for all the coefficients included in the quantized coefficient set, the circuit size can be reduced. Accordingly, the coefficient conversion device in the aspect of the present invention can be easily realized.

It should be noted that the present invention can be realized not only as the image coding device, the coding rate conversion device, the audio video stream recording device, the network distribution system, and the coefficient conversion device described above, but also as an image coding method, a coding rate conversion method, an audio video stream recording method, a network distribution method, and a coefficient conversion method which include steps corresponding to the characteristic units included in the image coding device, the coding rate conversion device, the audio video stream recording device, the network distribution system, and the coefficient conversion device, respectively. Moreover, the present invention can be realized as a program causing a computer to execute these characteristic steps. It should be obvious that such a program can be distributed via a recording medium such as a CD-ROM or via a transmission medium such as the Internet.

Furthermore, the present invention can be realized as an integrated circuit that implements the functions of the image coding device, the coding rate conversion device, the audio video stream recording device, the network distribution system, and the coefficient conversion device described above.

### Effects of the Invention

Accordingly, the present invention can provide the image coding device, the coding rate conversion device, the audio video stream recording device, the network distribution system, the coefficient conversion device, the integrated circuit, and the image coding method capable of reducing the amount of codes and the circuit size.

### BRIEF DESCRIPTION OF DRAWINGS

FIG. 1 is a diagram showing a structure of image data in MPEG-2 format.

FIG. 2A is a diagram showing a coding order in the case of zigzag scanning.

FIG. 2B is a diagram showing a coding order in the case of zigzag scanning.

FIG. 2C is a diagram showing a coding order in the case of alternate scanning.

FIG. 2D is a diagram showing a coding order in the case of alternate scanning.

FIG. 3 is a diagram showing a part of a coding table for a quantized coefficient set, according to MPEG-2.

FIG. 4 is a diagram showing an example of the amount of codes, according to MPEG-2.

FIG. 5 is a diagram showing syntax of variable-length decoding processing according to H.264/AVC.

FIG. 6 is a diagram showing a part of a coding table for TrailingOnes and TotalCoeff, according to H.264/AVC.

FIG. 7 is a diagram showing a part of a coding table for levels, according to H.264/AVC.

FIG. 8 is a diagram showing a part of a coding table for total_zeros, according to H.264/AVC.

FIG. 9 is a diagram showing a part of a coding table for run_before, according to H.264/AVC.

FIG. 10 is a diagram showing an example of the amount of codes, according to H.264/AVC.

FIG. 11A is a diagram showing an example of the quantized coefficient set and the amount of codes, according to MPEG-2.

FIG. 11B is a diagram showing an example of the quantized coefficient set and the amount of codes, according to MPEG-2.

FIG. 12 is a block diagram showing a configuration of a coefficient conversion device in a first embodiment of the present invention.

FIG. 13 is a flowchart showing the flow of coefficient conversion processing performed by the coefficient conversion device in the first embodiment of the present invention.

FIG. 14 is a diagram showing an example of the amount of codes in the case of the coefficient conversion device in the first embodiment of the present invention.

FIG. 15 is a diagram showing an example of the amount of codes in the case of the coefficient conversion device in the first embodiment of the present invention.

FIG. 16 is a diagram showing an example of the amount of codes in the case of the coefficient conversion device in the first embodiment of the present invention.

FIG. 17 is a diagram showing an example of the amount of codes in the case of the coefficient conversion device in the first embodiment of the present invention.

FIG. 18 is a block diagram showing a configuration of a coefficient conversion device in a second embodiment of the present invention.

FIG. 19 is a flowchart showing the flow of coefficient conversion processing performed by the coefficient conversion device in the second embodiment of the present invention.

FIG. 20 is a block diagram showing a configuration of an image coding device in a third embodiment of the present invention.

FIG. 21 is a block diagram showing a configuration of a coding rate conversion device in a fourth embodiment of the present invention.

FIG. 22 is a block diagram showing a configuration of an AV stream recording device in a fifth embodiment of the present invention.

FIG. 23 is a block diagram showing a configuration of a network distribution system in a sixth embodiment of the present invention.

FIG. 24 is a block diagram showing a configuration of an AV stream recording device in a seventh embodiment of the present invention.

FIG. 25 is a block diagram showing a configuration of a network distribution system in an eighth embodiment of the present invention.

### NUMERICAL REFERENCES

100, 200 Coefficient conversion device
101 Coefficient sequence extraction unit
102 Coefficient non-zeroing unit
103 First coefficient sequence code amount calculation unit
104 Second coefficient sequence coding amount calculation unit
105 Code amount comparison unit
106 Coefficient sequence selection unit
110, 111 Quantized coefficient set
112 First coefficient sequence
113 Second coefficient sequence
114, 115 Amount of codes
116 Determination result
202 Pre-quantized-nonzero-coefficient non-zeroing unit
207 Pre-quantized-coefficient-sequence extraction unit
217 Orthogonal transform coefficient set
218 Third coefficient sequence
301 Image coding device
302 Motion compensation unit
303 Orthogonal transform unit
304 Quantization unit
306 Variable-length coding unit
307 Inverse quantization unit
308 Inverse orthogonal transform unit
309 Reference image data storage unit
310 Image data
311 Coded image data
312 Difference data
313 Reference image data information
314 Orthogonal transform coefficient set
315 Reference image data
401 Coding rate conversion device
402 Variable-length decoding unit
403 Inverse quantization unit
404 Quantization unit
405 Quantization step conversion unit
407 Variable-length coding unit
410 Coded image data
411 Post-coding-rate-conversion coded image data
412 Quantized coefficient set
413 First quantization step
414 Second quantization step
501, 701 AV stream recording device
503, 705 AV multiplexing unit
504, 706, 805 HDD control unit
505, 707, 804 HDD
511, 710 Audio data
512, 711 System data
513, 709, 712, 812 AV stream
600, 800 Network distribution system
601, 801 AV stream sending device
602, 802 AV stream receiving device
603, 803 Network
606, 809 Network sending control unit
609, 810 Network receiving control unit
610, 811 AV reproduction unit
702 Broadcast receiving unit
703 AV demultiplexing unit
708 Digital broadcast wave
815 Coding rate
901 Image data
902 Picture
903 Slice
904 Macroblock
905 Luminance block
906 Chrominance block
907, 970, 971 Quantized coefficient set
908 Coefficient
910, 920, 930, 940, 950 Coding table
911 run
912, 931 level
913, 923, 933, 943, 953, 962 Code
914, 963 Number of bits
921 TrailingOnes
922 TotalCoeff
927 run_before
928 zerosLeft
932 suffixLength
941 total_zeros
961 Pre-coded data

### BEST MODE FOR CARRYING OUT THE INVENTION

The following describes embodiments of the present invention, with reference to the drawings.

### First Embodiment

A coefficient conversion device in the first embodiment of the present invention reduces the amount of codes by sequentially extracting first coefficient sequences from a quantized coefficient set and then converting, for each of the first coefficient sequences, a zero coefficient included in the first coefficient sequence into a nonzero coefficient.

Firstly, a configuration of the coefficient conversion device in the first embodiment of the present invention is explained.

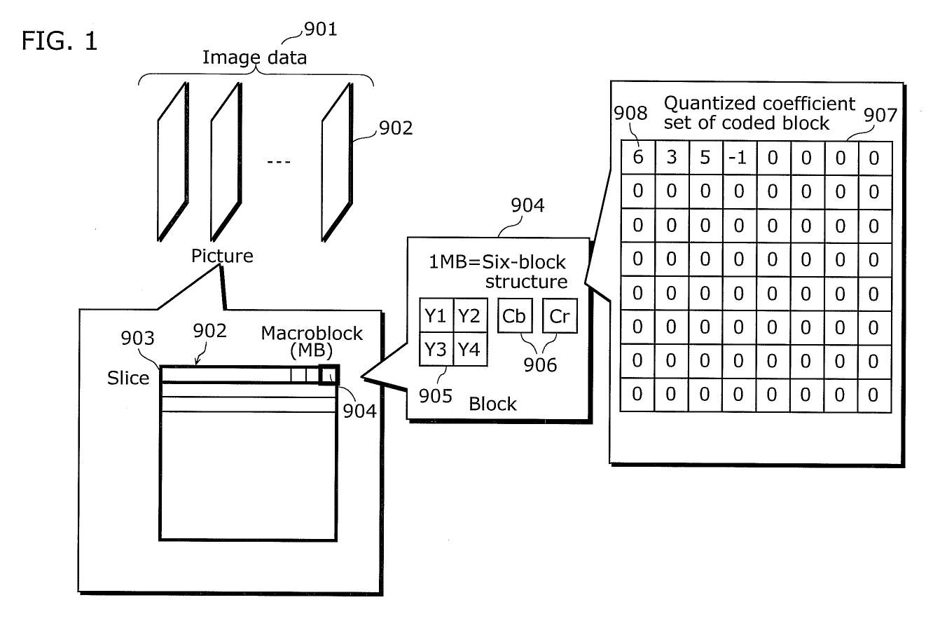

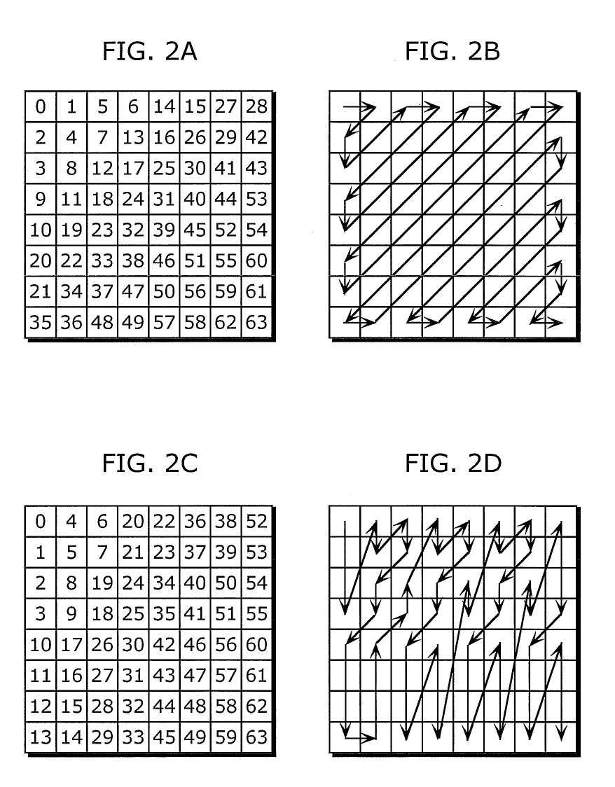

FIG. 1 is a block diagram showing the configuration of the coefficient conversion device in the first embodiment of the present invention.

A coefficient conversion device 100 shown in FIG. 1 is used in an image coding device, for example. The coefficient conversion device 100 converts a received quantized coefficient set 110 which corresponds to one coded block unit into a quantized coefficient set 111 on which variable-length coding is to be performed, and then outputs the converted quantized coefficient set 111. Here, the quantized coefficient set 110 refers to a coefficient sequence which corresponds to one quantized coded block unit.

This coefficient sequence is obtained by performing motion compensation and orthogonal transform on image data. One coded block unit corresponds to, for example, a block unit of the luminance blocks 905 or a block unit of the chrominance blocks 906 shown in FIG. 1.

This coefficient conversion device 100 includes a coefficient sequence extraction unit 101, a coefficient non-zeroing unit 102, a first coefficient sequence code amount calculation unit 103, a second coefficient sequence code amount calculation unit 104, a code amount comparison unit 105, and a coefficient sequence selection unit 106.

The coefficient sequence extraction unit 101 extracts a first coefficient sequence 112 included in the received quantized coefficient set 110 which corresponds to one coded block unit, the first coefficient sequence 112 having at least one coefficient. Then, the coefficient sequence extraction unit 101 outputs the extracted first coefficient sequence 112 to the coefficient non-zeroing unit 102, the first coefficient sequence code amount calculation unit 103, and the coefficient sequence selection unit 106. Here, the first coefficient sequence 112 is a coefficient sequence made up of consecutive coefficients, out of the coefficients of the quantized coefficient set 110 that are arranged in a scanning order (such as a zigzag scanning order).

The coefficient non-zeroing unit 102 converts at least one coefficient whose value is zero (namely, a zero coefficient) included in the first coefficient sequence 112 into a coefficient whose value is other than zero (namely, a nonzero coefficient). Then, the coefficient non-zeroing unit 102 generates a second coefficient sequence 113 including all the coefficients resulting from the conversion. It should be noted that converting a zero coefficient into a nonzero coefficient is also mentioned as “non-zeroing” hereafter. The coefficient non-zeroing unit 102 also outputs the generated second coefficient sequence 113 to the second coefficient sequence code amount calculation unit 104 and the code amount comparison unit 105. However, when a nonzero coefficient is not included in the first coefficient sequence 112, the coefficient non-zeroing unit 102 outputs the first coefficient sequence 112 as the second coefficient sequence as it is. Note that the zero coefficient mentioned here refers to a zero coefficient, out of zero coefficients included in the quantized coefficient set 110, that precedes the last nonzero coefficient in the scanning order.

The first coefficient sequence code amount calculation unit 103 calculates a code amount 114 of the first coefficient sequence 112, and outputs the calculated code amount 114 to the code amount comparison unit 105.

The second coefficient sequence code amount calculation unit 104 calculates a code amount 115 of the second coefficient sequence 113, and outputs the calculated code amount 115 to the code amount comparison unit 105.

By comparing the code amount 114 of the first coefficient sequence 112 with the code amount 115 of the second coefficient sequence 113, the code amount comparison unit 105 determines whether or not the code amount 115 of the second coefficient sequence 113 is smaller than the code amount of the first coefficient sequence 112. Then, the code amount comparison unit 105 outputs a determination result 116 to the coefficient sequence selection unit 106. To be more specific, when the code amount 115 of the second coefficient sequence 113 is smaller than the code amount 114 of the first coefficient sequence 112, the code amount comparison unit 105 performs control, causing the coefficient sequence selection unit 106 to select the second coefficient sequence 113. On the other hand, when the code amount 115 of the second coefficient sequence 113 is larger than or equal to the code amount 114 of the first coefficient sequence 112, the code amount comparison unit 105 performs control, causing the coefficient sequence selection unit 106 to select the first coefficient sequence 112.

In accordance with a notification from the code amount comparison unit 105, the coefficient sequence selection unit 106 selects the first coefficient sequence or the second coefficient sequence, and outputs the quantized coefficient set 111 including the selected coefficient sequence. More specifically, the coefficient sequence selection unit 106 selects the first coefficient sequence 112 or the second coefficient sequence 113 that has a smaller amount of codes when it is coded, as the quantized coefficient set 111 on which variable-length coding is to be performed. Then, the coefficient sequence selection unit 106 outputs this quantized coefficient set 111.

The operation performed by the coefficient conversion device 100 of the present invention is explained as follows, using an example according to MPEG-2.

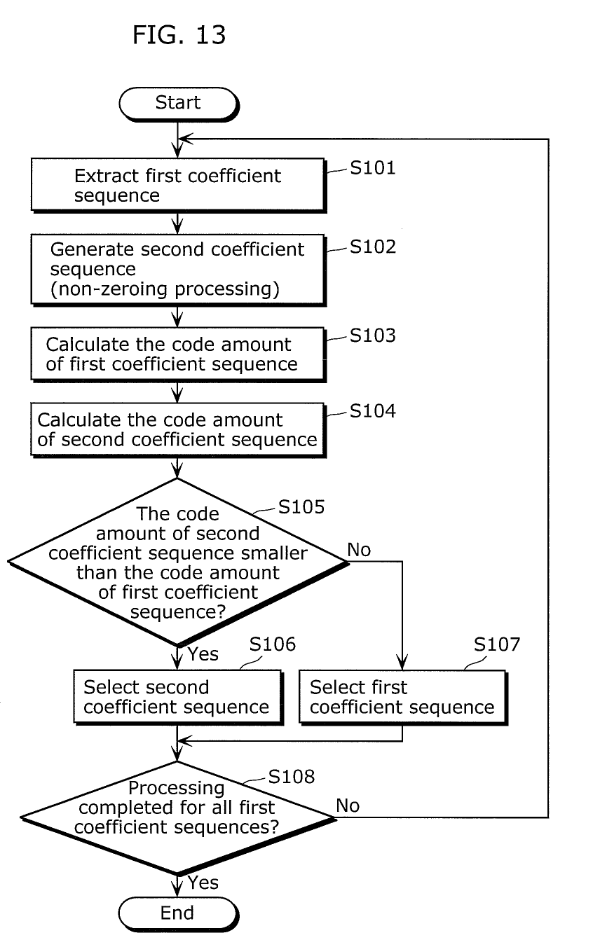

FIG. 13 is a flowchart showing the flow of coefficient conversion processing whereby the coefficient conversion device 100 converts the quantized coefficient set 110 that corresponds to one block.

From a coefficient sequence in which coefficients included in the quantized coefficient set 110 of one block are arranged in the scanning order, the coefficient sequence extraction unit 101 first extracts zero coefficients consecutive from the beginning of the present coefficient sequence and one nonzero coefficient following these zero coefficients, as the first coefficient sequence 112 (S101). The coefficient sequence extraction unit 101 outputs the extracted first coefficient sequence 112 to the coefficient non-zeroing unit 102, the first coefficient sequence code amount calculation unit 103, and the coefficient sequence selection unit 106.

Next, the coefficient non-zeroing unit 102 generates the second coefficient sequence 113 by non-zeroing the first coefficient sequence 112 (S102). To be more specific, the coefficient non-zeroing unit 102 generates the second coefficient sequence 113 by converting the last zero coefficient included in the first coefficient sequence into 1. Then, the coefficient non-zeroing unit 102 outputs the generated second coefficient sequence 113 to the second coefficient sequence code amount calculation unit 104 and the code amount comparison unit 105.

The first coefficient sequence code amount calculation unit 103 calculates the code amount 114 of the first coefficient sequence 112 using the number of consecutive zero coefficients (run) included in the first coefficient sequence 112 and the value of the nonzero coefficient (level), and then outputs the calculated code amount 114 to the code amount comparison unit 105 (S103).

The second coefficient sequence code amount calculation unit 104 calculates the code amount 115 of the second coefficient sequence 113 using the number of consecutive zero coefficients (run) and the value of the nonzero coefficient (level) which are included in the second coefficient sequence 113, and then outputs the calculated code amount 115 to the code amount comparison unit 105 (S104).

Next, the code amount comparison unit 105 compares the code amount 114 of the first coefficient sequence 112 with the code amount 115 of the second coefficient sequence 113, and then outputs the determination result to the coefficient sequence selection unit 106 (S105).

When the code amount 115 of the second coefficient sequence 113 is smaller than the code amount 114 of the first coefficient sequence 112 (Yes in S105), the coefficient sequence selection unit 106 selects the second coefficient sequence 113, and outputs the selected second coefficient sequence 113 (S106).

When the code amount 115 of the second coefficient sequence 113 is larger than or equal to the code amount 114 of the first coefficient sequence 112, the coefficient sequence selection unit 106 selects the first coefficient sequence 112, and outputs the selected first coefficient sequence 112 (S107).

After the end of step S106 or step S107, when the processing from step S101 to step S107 is not completed for all of the first coefficient sequences 112 included in the quantized coefficient set 110 that corresponds to one block (No in S108), the coefficient sequence extraction unit 101 extracts a first coefficient sequence 112 that is next located in the quantized coefficient set 110 in the scanning order (S101). The coefficient conversion device 100 performs the above-described processing from step S102 onward on the newly-extracted first coefficient sequence 112.

The above processing from step 5101 to step S107 is repeated until all the first coefficient sequences 112 included in the quantized coefficient set 110 have been extracted in step S101 (Yes in S108).

More specifically, the coefficient sequence extraction unit 101 extracts a plurality of first coefficient sequences 112 one by one from the quantized coefficient set 110. The coefficient non-zeroing unit 102 generates the second coefficient sequence 113 for each of the plurality of first coefficient sequences 112 extracted by the coefficient sequence extraction unit 101. For each of the plurality of first coefficient sequences 112 extracted by the coefficient sequence extraction unit 101, the coefficient sequence selection unit 106 makes a selection between the present first coefficient sequence 112 and the second coefficient sequence 113 that corresponds to the present first coefficient sequence 112. In selecting, the coefficient sequence selection unit 106 selects the coefficient sequence whose amount of codes is smaller when it is coded.

It should be noted that the order in which the above-described processing of calculating the code amount 114 of the first coefficient sequence 112 (S103) and the above-described processing of calculating the code amount 115 of the second coefficient sequence 113 (S104) are performed is arbitrary. Moreover, the processing of calculating the code amount 114 of the first coefficient sequence 112 (S103) may be performed before the processing of generating the second coefficient sequence 113 (S102). Furthermore, parts of the processing from step S102 to step S104 may be performed in parallel.

Also, whenever selecting the first coefficient sequence 112 or the second coefficient sequence 113 in step S106 or step S107, the coefficient sequence selection unit 106 may output the selected coefficient sequence. Or, after making a selection, for each of the first coefficient sequences 112 included in the quantized coefficient set 110 that corresponds one block, between the first coefficient sequence 112 or the second coefficient sequence 113 that corresponds to the first coefficient sequence 112, the coefficient sequence selection unit 106 may output the post-conversion quantized coefficient set 111 including all the first coefficient sequences 112 and second coefficient sequences 113 that have been selected.

The operation performed by the coefficient conversion device 100 is explained using specific examples of coefficient sequences.

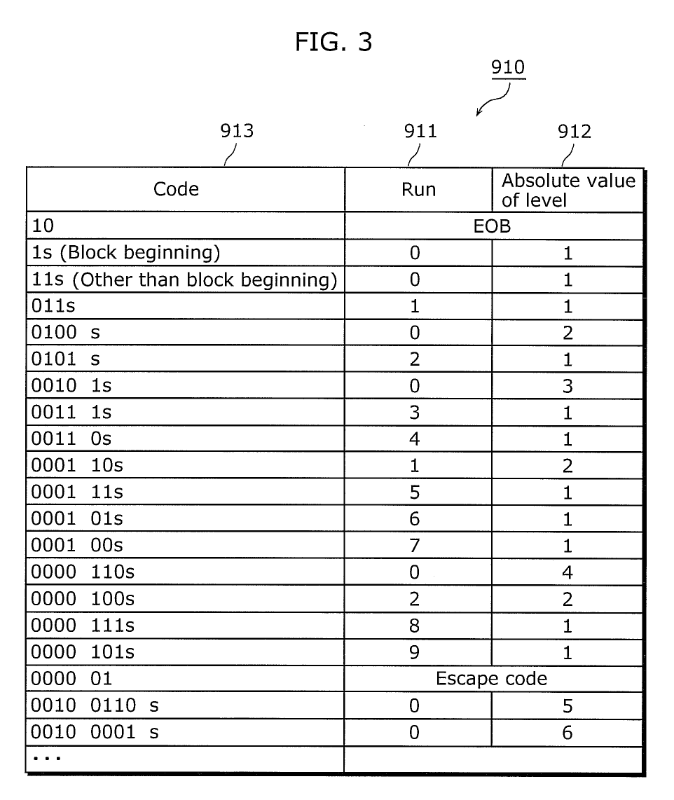

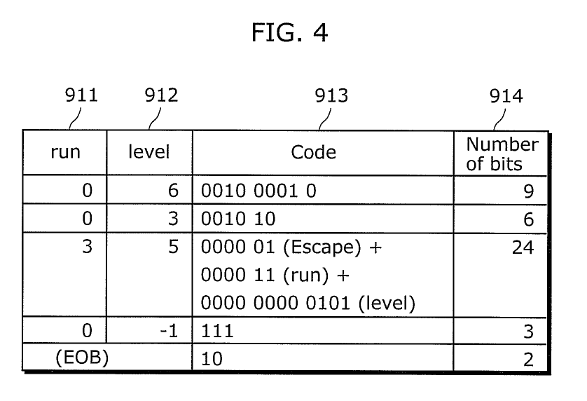

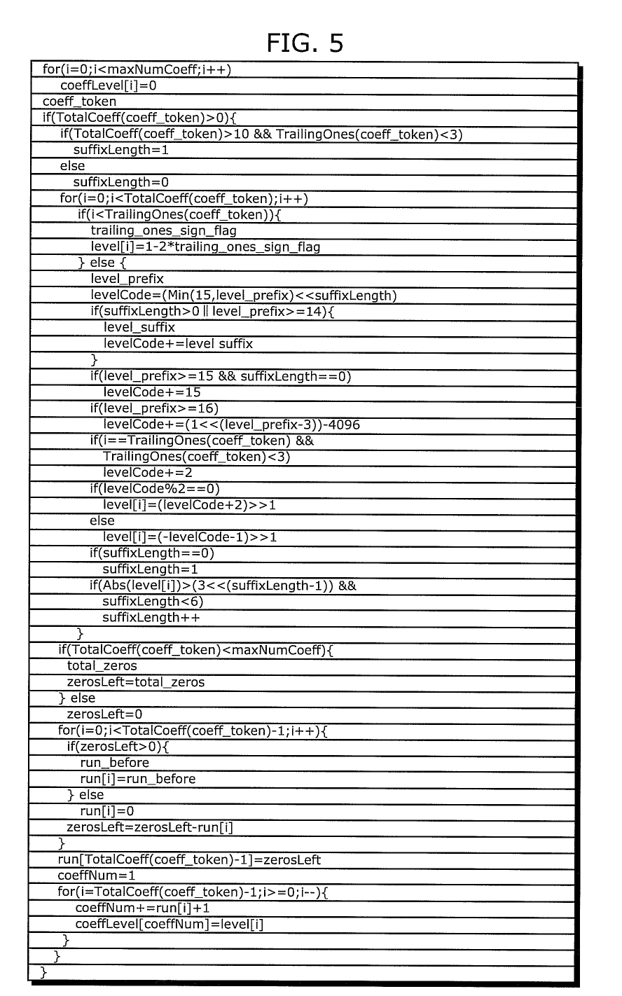

First, an example where non-zeroing is not performed, that is, where the first coefficient sequence 112 is outputted is explained. Note that the first coefficient sequence 112 is “0, 0, 0, 1” and the coding table 910 shown in FIG. 3 is used.

The coefficient sequence extraction unit 101 first extracts the first coefficient sequence 112 “0, 0, 0, 1” included in the quantized coefficient set 110 (S101).

Next, the coefficient non-zeroing unit 102 outputs the second coefficient sequence 113 “0, 0, 1, 1” where the last zero coefficient of the first coefficient sequence 112 has been converted into 1 (S102).

Then, the first coefficient sequence code amount calculation unit 103 outputs the code amount 114 of the first coefficient sequence 112. Here, since the run is 3 and the level is 1, the first coefficient sequence code amount calculation unit 103 outputs 6 bits as the code amount 114 (S103).

The second coefficient sequence code amount calculation unit 104 outputs the code amount 115 of the second coefficient sequence 113. Here, since (run, level)=(2, 1) and (0, 1), the second coefficient sequence code amount calculation unit 104 outputs 8 bits as the code amount 115 (S104).

Since the code amount 115 of the second coefficient sequence 113 (i.e., 8 bits) is larger than the code amount 114 of the first coefficient sequence 112 (i.e., 6 bits) (No in S105), the code amount comparison unit 105 notifies the coefficient sequence selection unit 106 to select the first coefficient sequence 112 having a smaller amount of codes. Thus, the the coefficient sequence selection unit 106 outputs the first coefficient sequence 112 (S107).

Accordingly, the first coefficient sequence 112 having a smaller amount of codes than the second coefficient sequence 113 is outputted.

Next, an example where non-zeroing is performed, that is, where the second coefficient sequence 113 is outputted is explained. Note that the first coefficient sequence 112 is “0, 0, 0, 0, 5” and the coding table 910 shown in FIG. 3 is used.

The coefficient sequence extraction unit 101 first extracts the first coefficient sequence 112 “0, 0, 0, 0, 5” included in the quantized coefficient set 110 (S101).

Next, the coefficient non-zeroing unit 102 outputs the second coefficient sequence 113 “0, 0, 0, 1, 5” where the last zero coefficient of the first coefficient sequence 112 has been converted into 1 (S102).

Then, the first coefficient sequence code amount calculation unit 103 outputs the code amount 114 of the first coefficient sequence 112. Here, since the run is 4 and the level is 5, an Escape code is required. Thus, the first coefficient sequence code amount calculation unit 103 outputs 24 bits as the code amount 114 (S103).

The second coefficient sequence code amount calculation unit 104 outputs the code amount 115 of the second coefficient sequence 113. Here, since (run, level)=(3, 1) and (0, 5), the second coefficient sequence code amount calculation unit 104 outputs 15 bits as the code amount 115 (S104).

Since the code amount 115 of the second coefficient sequence 113 (i.e., 15 bits) is smaller than the code amount 114 of the first coefficient sequence 112 (i.e., 24 bits) (Yes in S105), the code amount comparison unit 105 notifies the coefficient sequence selection unit 106 to select the second coefficient sequence 113 having a smaller amount of codes. Thus, the the coefficient sequence selection unit 106 outputs the second coefficient sequence 113 (S106).

Accordingly, the second coefficient sequence 113 having a smaller amount of codes than the first coefficient sequence 112 is outputted. Therefore, the amount of codes is reduced.

Next, the operation performed by the coefficient conversion device 100 of the present invention is explained using an example according to H.264/AVC.

From a coefficient sequence where all the coefficients included in the block of the quantized coefficient set 110 have been scanned, the coefficient sequence extraction unit 101 first extracts a coefficient sequence excluding the last consecutive zero coefficients, as the first coefficient sequence 112 (S101). In other words, from a coefficient sequence in which all the coefficients included in the quantized coefficient set 110 are arranged in the scanning order, the coefficient sequence extraction unit 101 extracts a sequence from the beginning to the last nonzero coefficient of the present coefficient sequence, as the first coefficient sequence 112. The coefficient sequence extraction unit 101 outputs the extracted first coefficient sequence 112 to the coefficient non-zeroing unit 102, the first coefficient sequence code amount calculation unit 103, and the coefficient sequence selection unit 106.

Next, the coefficient non-zeroing unit 102 generates the second coefficient sequence 113 by converting the last zero coefficient of the first coefficient sequence 112 into 1. Then, the coefficient non-zeroing unit 102 outputs the generated second coefficient sequence 113 to the second coefficient sequence code amount calculation unit 104 and the code amount comparison unit 105 (S102).

The first coefficient sequence code amount calculation unit 103 calculates the amount of codes for each of TotalCoeff, TrailingOnes, trailing_ones_sing_flag, level, total_zeros, and run_before, and sums up the calculated amounts of coding. Then, the first coefficient sequence code amount calculation unit 103 outputs the sum as the code amount 114 to the code amount comparison unit 105 (S103).

In the same manner as the first coefficient sequence code amount calculation unit 103 does, the second coefficient sequence code amount calculation unit 104 calculates the amount of codes for each code of the second coefficient sequence 113 and sums up the calculated amounts of coding. Then, the second coefficient sequence code amount calculation unit 104 outputs the sum as the code amount 115 to the code amount comparison unit 105 (S104).

Next, the code amount comparison unit 105 compares the code amount 114 of the first coefficient sequence with the code amount 115 of the second coefficient sequence, and notifies the coefficient sequence selection unit 106 to select the coefficient sequence which has a smaller amount of codes. In accordance with the notification from the code amount comparison unit 105, the coefficient sequence selection unit 106 outputs the first coefficient sequence or the second coefficient sequence.

To be more specific, when the code amount 115 of the second coefficient sequence 113 is smaller than the code amount 114 of the first coefficient sequence 112 (Yes in S105), the coefficient sequence selection unit 106 selects the second coefficient sequence 113, and outputs the selected second coefficient sequence 113 (S106).

When the code amount 115 of the second coefficient sequence 113 is larger than or equal to the code amount 114 of the first coefficient sequence 112, the coefficient sequence selection unit 106 selects the first coefficient sequence 112, and outputs the selected first coefficient sequence 112 (S107).

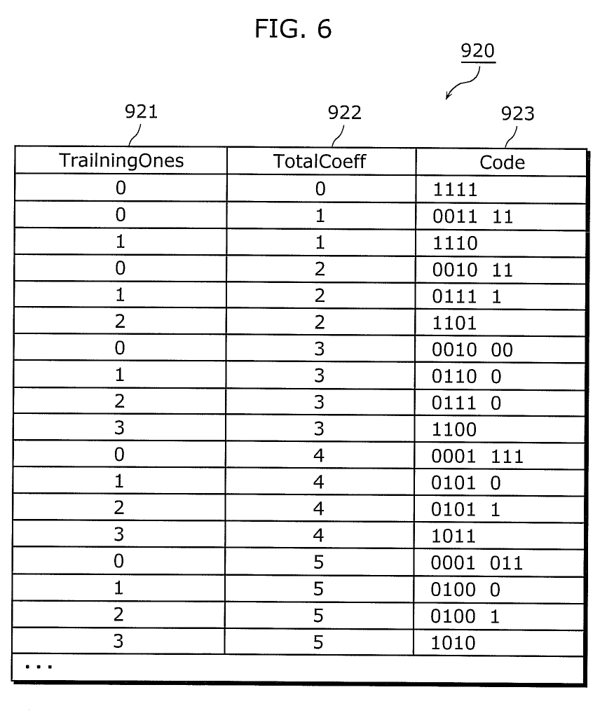

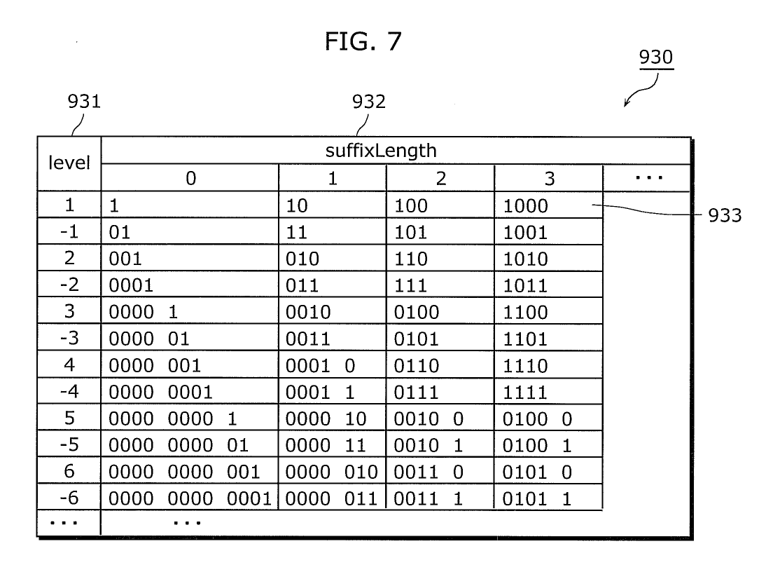

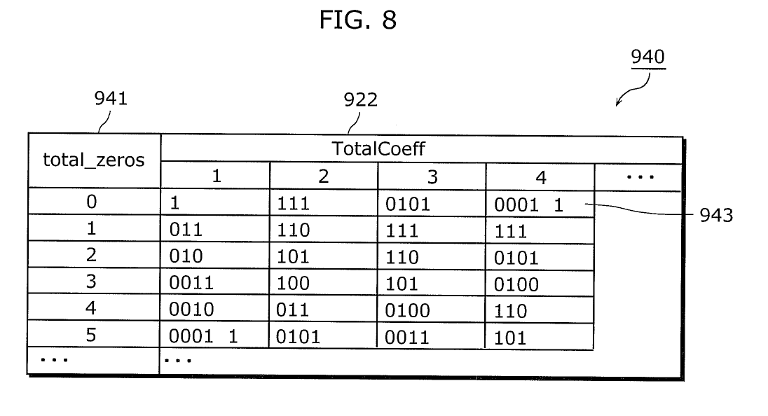

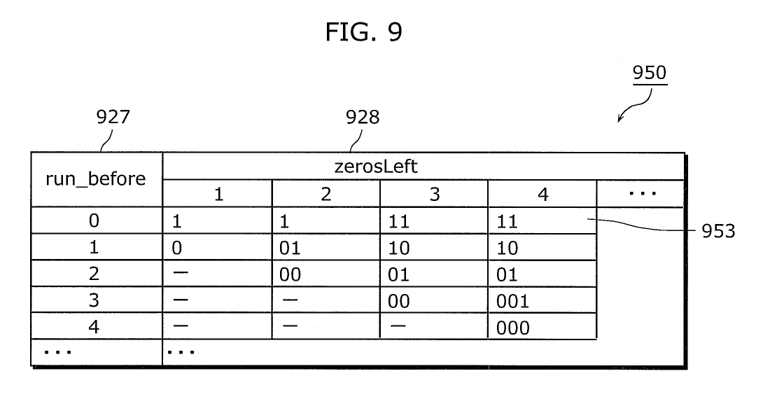

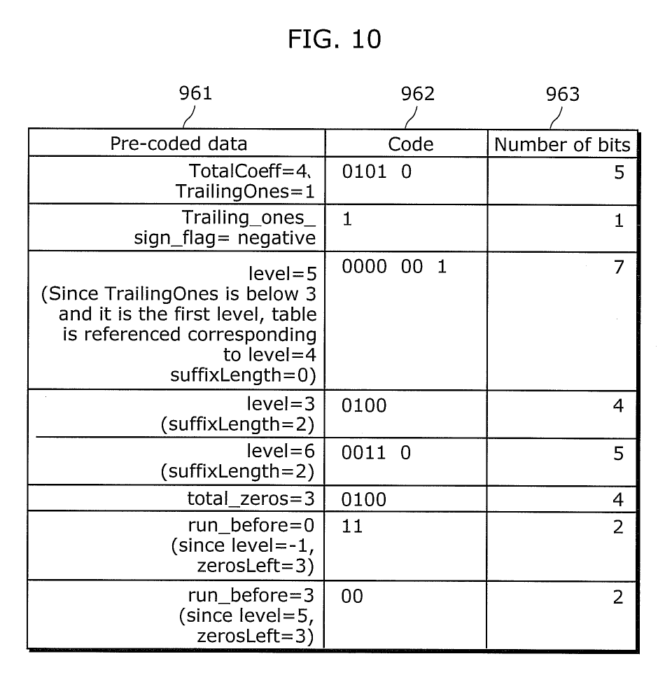

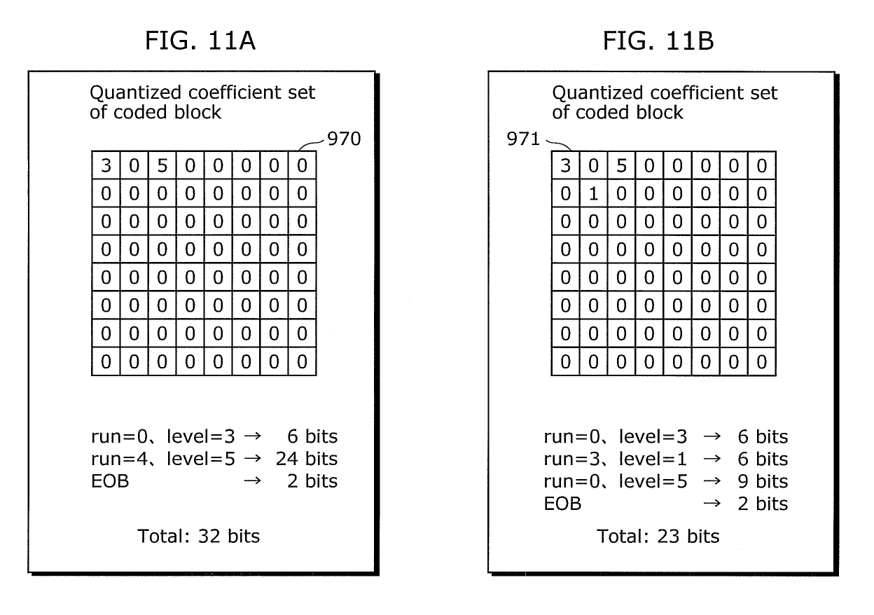

The operation performed by the coefficient conversion device 100 according to H.264/AVC is explained using specific examples of coefficient sequences as follows. In the following examples, the coding tables 920, 930, 940, and 950 shown in FIGS. 6 to 9 are used.

First, an example where non-zeroing is not performed, that is, where the first coefficient sequence 112 is outputted is explained. Note that the first coefficient sequence 112 is “3, 0, 1, 0, 1”

The coefficient sequence extraction unit 101 first extracts the first coefficient sequence 112 “3, 0, 1, 0, 1” from the quantized coefficient set 110 (S101).

Next, the coefficient non-zeroing unit 102 outputs the second coefficient sequence 113 “3, 0, 1, 1, 1” where the last zero coefficient included in the first coefficient sequence 112 has been converted into 1 (S102).

Then, the first coefficient sequence code amount calculation unit 103 outputs the code amount 114 of the first coefficient sequence 112.

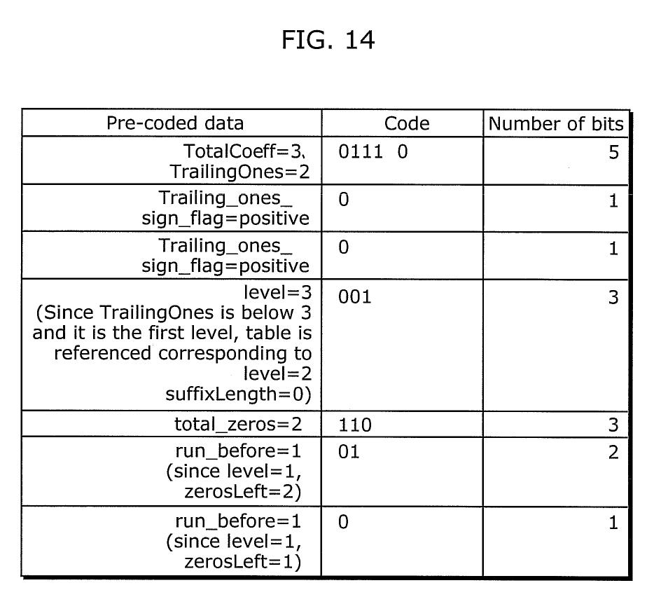

FIG. 14 is a diagram showing the amount of codes of the first coefficient sequence 112 “3, 0, 1, 0, 1”. As shown in FIG. 14, the first coefficient sequence code amount calculation unit 103 outputs 16 bits as the code amount 114 of the first coefficient sequence 112 (S103).

The second coefficient sequence code amount calculation unit 104 outputs the code amount 115 of the second coefficient sequence 113.

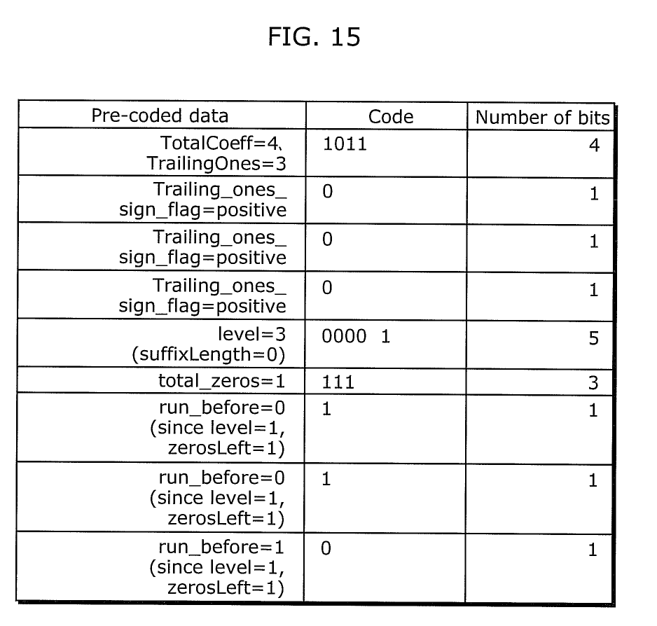

FIG. 15 is a diagram showing the amount of codes of the second coefficient sequence 113 “3, 0, 1, 1, 1”. As shown in FIG. 15, the second coefficient sequence code amount calculation unit 104 outputs 18 bits as the code amount 115 of the second coefficient sequence 113 (S104).

Since the code amount 115 of the second coefficient sequence 113 (i.e., 18 bits) is larger than the code amount 114 of the first coefficient sequence 112 (i.e., 16 bits) (No in S105), the code amount comparison unit 105 notifies the coefficient sequence selection unit 106 to select the first coefficient sequence having a smaller amount of codes. Thus, the the coefficient sequence selection unit 106 outputs the first coefficient sequence 112 (S107).

Accordingly, the first coefficient sequence 112 having a smaller amount of codes than the second coefficient sequence 113 is outputted.

Next, an example where non-zeroing is performed, that is, where the second coefficient sequence 113 is outputted is explained. Note that the first coefficient sequence 112 is “5, 1, 1, 0, 1”

The coefficient sequence extraction unit 101 first extracts the first coefficient sequence 112 “5, 1, 1, 0, 1” from the quantized coefficient set 110 (S101).

Next, the coefficient non-zeroing unit 102 outputs the second coefficient sequence 113 “5, 1, 1, 1, 1” where the last zero coefficient included in the first coefficient sequence 112 has been converted into 1 (S102).

Then, the first coefficient sequence code amount calculation unit 103 outputs the code amount 114 of the first coefficient sequence 112.

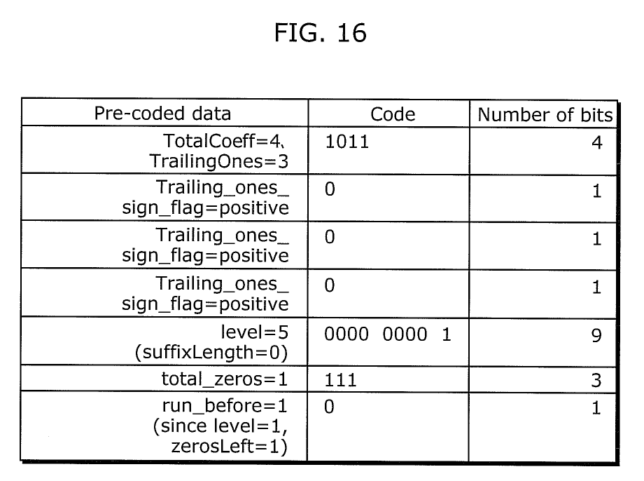

FIG. 16 is a diagram showing the amount of codes of the first coefficient sequence 112 “5, 1, 1, 0, 1”. As shown in FIG. 16, the first coefficient sequence code amount calculation unit 103 outputs 20 bits as the code amount 114 of the first coefficient sequence 112 (S103).

Next, the second coefficient sequence code amount calculation unit 104 outputs the code amount 115 of the second coefficient sequence 113.

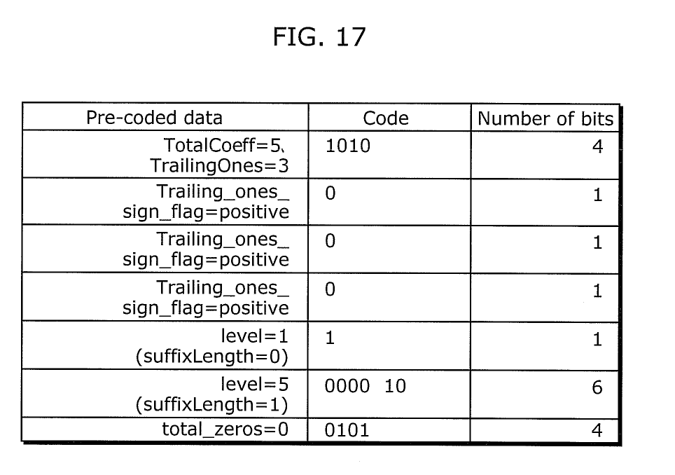

FIG. 17 is a diagram showing the amount of codes of the second coefficient sequence 113 “5, 0, 1, 1, 1”. As shown in FIG. 17, the second coefficient sequence code amount calculation unit 104 outputs 18 bits as the code amount 115 of the second coefficient sequence 113 (S104).

Since the code amount 115 of the second coefficient sequence 113 (i.e., 18 bits) is smaller than the code amount 114 of the first coefficient sequence 112 (i.e., 20 bits) (Yes in S105), the code amount comparison unit 105 notifies the coefficient sequence selection unit 106 to select the second coefficient sequence 113 having a smaller amount of codes. Thus, the the coefficient sequence selection unit 106 outputs the second coefficient sequence 113 (S106).

Accordingly, the second coefficient sequence 113 having a smaller amount of codes than the first coefficient sequence 112 is outputted. Therefore, the amount of codes is reduced.

As described thus far, the coefficient conversion device 100 in the first embodiment of the present invention can reduce the amount of codes by non-zeroing a coefficient included in the quantized coefficient set 110.

Moreover, the coefficient conversion device 100 in the first embodiment of the present invention performs the coefficient conversion processing for each of the first coefficient sequences 112 included in the quantized coefficient set 110. Thus, as compared with the case where the coefficient conversion processing is performed for the quantized coefficient set 110 that corresponds to one block, the circuit configuration and memory necessary for the coefficient conversion processing can be reduced. On account of this, the coefficient conversion device 100 can be easily implemented.

In the above example of the operation according to MPEG-2, the case of using the coding table 910 shown in FIG. 3 is described. However, the same discussion as above can be applied in the case where a different coding table according to MPEG-2 is used.

Moreover, in the above example of the operation according to H.264/AVC, the case of using the coding tables 920, 930, 940, and 950 shown in FIGS. 6 to 9 is described. However, the same discussion as above can be applied in the case where a different coding table according to H.264/AVC is used.

Furthermore, in the above description for the first embodiment, the case of using the coding method according to MPEG-2 and H.264/AVC is explained as an example. However, the same discussion as above can be applied in the case where a coding method according to a different image coding standard is used.

Also, in the above description for the first embodiment, the second coefficient sequence 113 is generated by non-zeroing the last zero coefficient of the first coefficient sequence 112. However, the same discussion as above can be applied in the case of non-zeroing a zero coefficient other than the last zero coefficient. However, note that when both the level and the run are larger, the amount of codes increases more, in general. To be more specific, when the level of the original first coefficient sequence 112 is large, the run corresponding to this large level can be converted into “0” by non-zeroing the last zero coefficient of the first coefficient sequence 112. Accordingly, the amount of codes can be efficiently reduced.

Moreover, in the above description for the first embodiment, a zero coefficient is converted into 1. However, the same discussion as above can be applied in the case where a different non-zeroing method is used. For example, a zero coefficient can be converted into “−1”. It should be noted that, considering that the amount of codes and a change (or, image degradation) from the original image are small when the absolute value of the level is “1” (i.e., the effect of reducing the amount of codes is large), it is preferable to convert the zero coefficient into “1” or “−1”.

Furthermore, in the above description for the first embodiment, the coefficient conversion device 100 generates one second coefficient sequence 113 corresponding to the first coefficient sequence 112. However, when a plurality of zero coefficients are included in the first coefficient sequence 112, a plurality of second coefficient sequences 113 in which non-zeroing has been performed on different zero coefficients may be generated. In such a case, among from the first coefficient sequence 112 and the plurality of second coefficient sequences 113, a coefficient sequence having the smallest amount of codes may be outputted.

### Second embodiment

A coefficient conversion device 200 in the second embodiment of the present invention generates a second coefficient sequence 113 by converting a zero coefficient, out of zero coefficients included in a first coefficient sequence 112, that was a nonzero coefficient before quantization into a nonzero coefficient. Accordingly, the coefficient conversion device 200 in the second embodiment of the present invention can prevent image degradation that may be caused by the conversion.

First, a configuration of the coefficient conversion device 200 in the second embodiment of the present invention is explained.

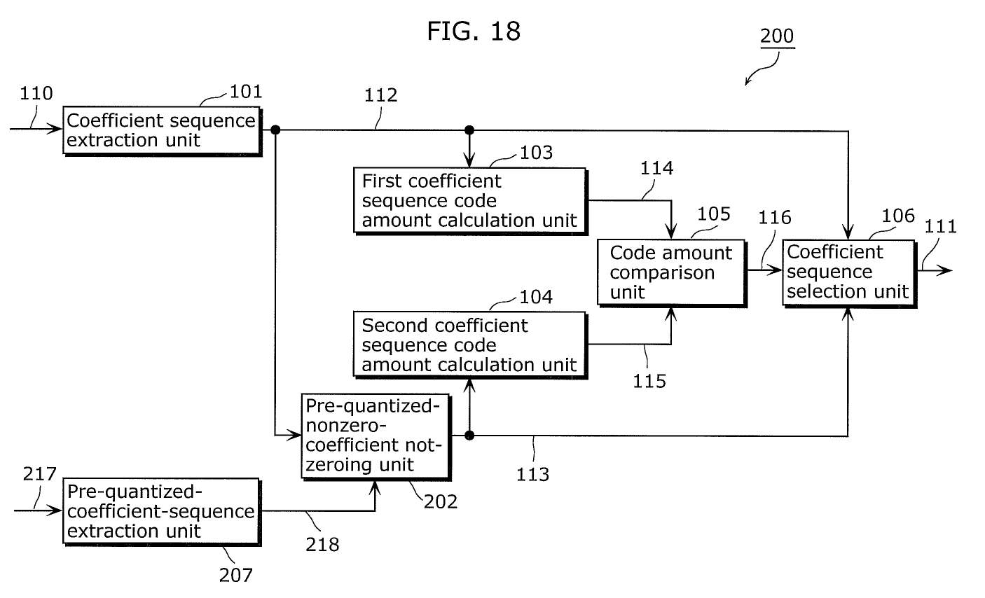

FIG. 18 is a diagram showing the configuration of the coefficient conversion device in the second embodiment of the present invention.

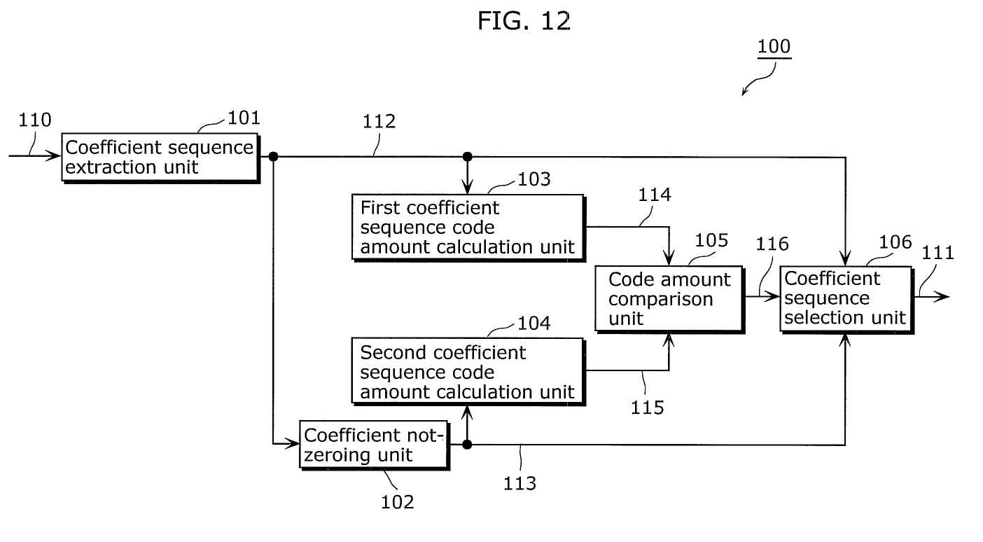

As compared with the coefficient conversion device 100 shown in FIG. 12, the coefficient conversion device 200 shown in FIG. 18 includes a pre-quantized-nonzero-coefficient non-zeroing unit 202 that replaces the coefficient non-zeroing unit 102, and further includes a pre-quantized-coefficient-sequence extraction unit 207. It should be noted that components which are the same as those shown in FIG. 12 are assigned the same reference numerals as in FIG. 12 and the explanation for these components is not repeated.

The pre-quantized-coefficient-sequence extraction unit 207 extracts a third coefficient sequence 218 that corresponds to the first coefficient sequence 112 from a pre-quantized orthogonal transform coefficient set (DCT coefficient set) 217. Then, the pre-quantized-coefficient-sequence extraction unit 207 outputs the extracted third coefficient sequence 218 to the pre-quantized-nonzero-coefficient non-zeroing unit 202. To be more specific, the pre-quantized-coefficient-sequence extraction unit 207 obtains the third coefficient sequence which is a pre-quantized first coefficient sequence 112. The orthogonal transform coefficient set 217 is a coefficient sequence that is obtained by performing motion compensation and orthogonal transform on the image data.

The pre-quantized-nonzero-coefficient non-zeroing unit 202 generates the second coefficient sequence 113 by non-zeroing at least one zero coefficient that was a nonzero coefficient before quantization. That is, out of the zero coefficients included in the first coefficient sequence 112, the pre-quantized-nonzero-coefficient non-zeroing unit 202 converts the zero coefficient, whose corresponding coefficient in the orthogonal transform coefficient set 217 (namely, the third coefficient sequence 218) is nonzero, into a nonzero coefficient. For example, when the coefficient included in the orthogonal transform coefficient set 217 (namely, the third coefficient sequence 218) that corresponds to the zero coefficient to be converted into a nonzero coefficient is a positive coefficient, the pre-quantized-nonzero-coefficient non-zeroing unit 202 converts this zero coefficient into 1. On the other hand, when the coefficient included in the orthogonal transform coefficient set 217 (namely, the third coefficient sequence 218) that corresponds to the zero coefficient to be converted into a nonzero coefficient is a negative coefficient, the pre-quantized-nonzero-coefficient non-zeroing unit 202 converts this zero coefficient into −1. The pre-quantized-nonzero-coefficient non-zeroing unit 202 outputs the generated second coefficient sequence 113 to the second coefficient sequence code amount calculation unit 104 and the code amount comparison unit 105.

Next, the operation performed by the coefficient conversion device 200 is explained.

The operation performed by the coefficient conversion device 200 is explained as follows, using an example according to MPEG-2. It should be noted that the coefficient conversion device 200 calculates the amount of codes using the coding table shown in FIG. 3 as in the case of the first embodiment. Also note that the pre-quantized-nonzero-coefficient non-zeroing unit 202 converts the last nonzero coefficient, out of zero coefficients whose values were nonzero before quantization, into 1 when the pre-quantized coefficient is a positive value and into −1 when the pre-quantized coefficient is a negative value.

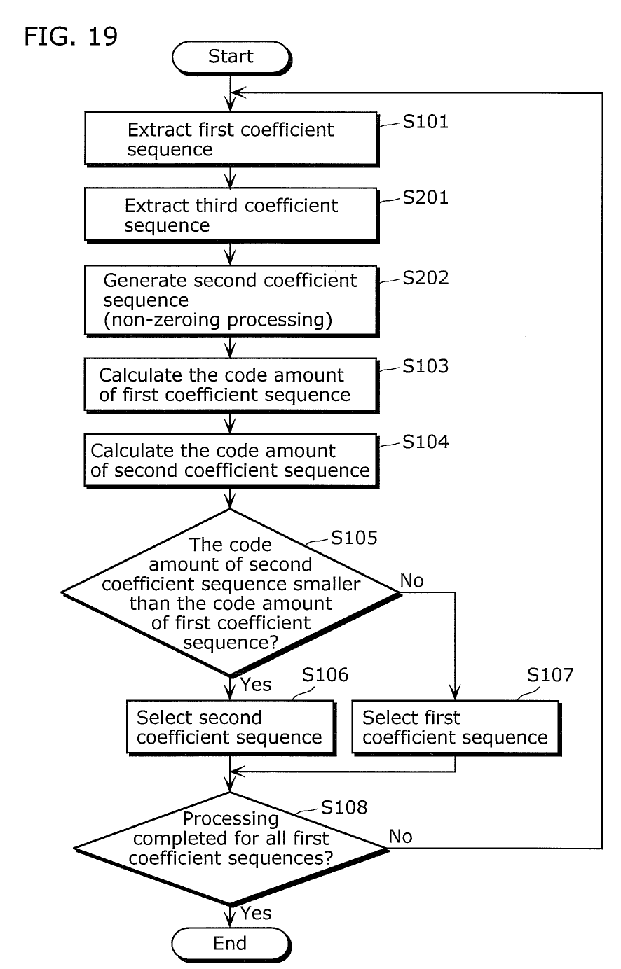

FIG. 19 is a flowchart showing the flow of coefficient conversion processing performed by the coefficient conversion device 200. Note that processes which are the same as those in FIG. 13 are assigned the same reference numerals as used in FIG. 13.

First, an example where non-zeroing is not performed, that is, where the first coefficient sequence is outputted is explained.

Note that the first coefficient sequence 112 is “0,0,0,1”, and the third coefficient sequence 218 is “1, −2, 0, 10”.

The coefficient sequence extraction unit 101 first extracts the first coefficient sequence 112 “0, 0, 0, 1” from the quantized coefficient set 110 (S101).

Next, the pre-quantized-coefficient-sequence extraction unit 207 extracts the third coefficient sequence 218 “1, −2, 0, 10) from the pre-quantized orthogonal transform coefficient set 217, and then outputs the extracted third coefficient sequence 218 to the pre-quantized-nonzero-coefficient non-zeroing unit 202 (S201).

Then, the pre-quantized-nonzero-coefficient non-zeroing unit 202 converts a zero coefficient, out of the zero coefficients included in the first coefficient sequence 112, into a nonzero coefficient, that is the last zero coefficient in the first coefficient sequence 112 and that is a nonzero coefficient in the third coefficient sequence 218 (S202). More specifically, the pre-quantized-nonzero-coefficient non-zeroing unit 202 generates the second coefficient sequence 113 “0, −1, 0, 1” by converting the second zero coefficient of the first coefficient sequence 112 into −1.

Next, the first coefficient sequence code amount calculation unit 103 calculates the code amount 114 of the first coefficient sequence 112 (i.e., 6 bits) (S103).

The second coefficient sequence code amount calculation unit 104 calculates the code amount 115 of the second coefficient sequence 113 (i.e., 8 bits) (S104).

Then, since the code amount 115 of the second coefficient sequence 113 (i.e., 8 bits) is larger than the code amount 114 of the first coefficient sequence 112 (i.e., 6 bits) (No in S105), the code amount comparison unit 105 notifies the coefficient sequence selection unit 106 to select the first coefficient sequence having a smaller amount of codes. Thus, the the coefficient sequence selection unit 106 outputs the first coefficient sequence 112 (S107).

Accordingly, the first coefficient sequence 112 having a smaller amount of codes than the second coefficient sequence 113 is outputted.

Next, an example where non-zeroing is performed, that is, where the second coefficient sequence is outputted is explained. Note that the first coefficient sequence 112 is “0, 0, 0, 0, 5”, and the third coefficient sequence 218 is “0, 1, −2, 0, 20”.

The coefficient sequence extraction unit 101 first extracts the first coefficient sequence 112 “0, 0, 0, 0, 5” from the quantized coefficient set 110 (S101).

Next, the pre-quantized-coefficient-sequence extraction unit 207 extracts the third coefficient sequence 218 “0, 1, −2, 0, 20” from the pre-quantized orthogonal transform coefficient set 217, and then outputs the extracted third coefficient sequence 218 to the pre-quantized-nonzero-coefficient non-zeroing unit 202 (S201).

Then, the pre-quantized-nonzero-coefficient non-zeroing unit 202 converts a zero coefficient, out of the zero coefficients included in the first coefficient sequence 112, into a nonzero coefficient, that is the last zero coefficient in the first coefficient sequence 112 and that is a nonzero coefficient in the third coefficient sequence 218 (S202). More specifically, the pre-quantized-nonzero-coefficient non-zeroing unit 202 generates the second coefficient sequence 113 “0, 0, −1, 0, 5” by converting the third zero coefficient of the first coefficient sequence 112 into −1.

Then, the first coefficient sequence code amount calculation unit 103 calculates the code amount 114 of the first coefficient sequence 112 (i.e., 24 bits) (S103).

The second coefficient sequence code amount calculation unit 104 calculates the code amount 115 of the second coefficient sequence 113 (i.e., 18 bits) (S104).

Then, since the code amount 115 of the second coefficient sequence 113 (i.e., 15 bits) is smaller than the code amount 114 of the first coefficient sequence 112 (i.e., 24 bits) (Yes in S105), the code amount comparison unit 105 notifies the coefficient sequence selection unit 106 to select the second coefficient sequence 113 having a smaller amount of codes. Thus, the coefficient sequence selection unit 106 outputs the second coefficient sequence 113 (S106).

Accordingly, the second coefficient sequence 113 having a smaller amount of codes than the first coefficient sequence 112 is outputted. Therefore, the amount of codes is reduced.

Next, the operation performed by the coefficient conversion device 200 is explained using an example according to H.264/AVC. In the following examples, the coding tables 920, 930, 940, and 950 shown in FIGS. 6 to 9 are used as in the case of the first embodiment. Also note that the pre-quantized-nonzero-coefficient non-zeroing unit 202 converts the last nonzero coefficient, out of zero coefficients whose values were nonzero before quantization, into 1 when the pre-quantized coefficient is a positive value and into −1 when the pre-quantized coefficient is a negative value.

First, an example where non-zeroing is not performed, that is, where the first coefficient sequence 112 is outputted is explained. Note that the first coefficient sequence 112 is “3, 1, 0, 0, 1”, and the third coefficient sequence 218 is “15, 5, −2, 0, 7”.

The coefficient sequence extraction unit 101 first extracts the first coefficient sequence 112 “3, 1, 0, 0, 1” from the quantized coefficient set 110 (S101).

Next, the pre-quantized-coefficient-sequence extraction unit 207 extracts the third coefficient sequence 218 “15, 5, −2, 0, 7) from the pre-quantized orthogonal transform coefficient set 217, and then outputs the extracted third coefficient sequence 218 to the pre-quantized-nonzero-coefficient non-zeroing unit 202 (S201).

Then, the pre-quantized-nonzero-coefficient non-zeroing unit 202 converts a zero coefficient, out of the zero coefficients included in the first coefficient sequence 112, into a nonzero coefficient, that is the last zero coefficient in the first coefficient sequence 112 and that is a nonzero coefficient in the third coefficient sequence 218 (S202). More specifically, the pre-quantized-nonzero-coefficient non-zeroing unit 202 generates the second coefficient sequence 113 “3, 1, −1, 0, 1” by converting the third zero coefficient of the first coefficient sequence 112 into −1.

Next, the first coefficient sequence code amount calculation unit 103 calculates the code amount 114 of the first coefficient sequence 112 (i.e., 15 bits) (S103).

The second coefficient sequence code amount calculation unit 104 calculates the code amount 115 of the second coefficient sequence 113 (i.e., 16 bits) (S104).

Then, since the code amount 115 of the second coefficient sequence 113 (i.e., 16 bits) is larger than the code amount 114 of the first coefficient sequence 112 (i.e., 15 bits) (No in S105), the code amount comparison unit 105 notifies the coefficient sequence selection unit 106 to select the first coefficient sequence 112 having a smaller amount of codes. Thus, the the coefficient sequence selection unit 106 outputs the first coefficient sequence 112 (S107).

Accordingly, the first coefficient sequence 112 having a smaller amount of codes than the second coefficient sequence 113 is outputted.

Next, an example where non-zeroing is performed, that is, where the second coefficient sequence is outputted is explained. Note that the first coefficient sequence 112 is “5, 1, 1, 0, 0, 1”, and the third coefficient sequence 218 is “50, 12, 13, −2, 0, 11”.

The coefficient sequence extraction unit 101 first extracts the first coefficient sequence 112 “5, 1, 1, 0, 0, 1” from the quantized coefficient set 110 (S101).

Next, the pre-quantized-coefficient-sequence extraction unit 207 extracts the third coefficient sequence 218 “50, 12, 13, −2, 0, 11” from the pre-quantized orthogonal transform coefficient set 217, and then outputs the extracted third coefficient sequence 218 to the pre-quantized-nonzero-coefficient non-zeroing unit 202 (S201).

Then, the pre-quantized-nonzero-coefficient non-zeroing unit 202 converts a zero coefficient, out of the zero coefficients included in the first coefficient sequence 112, into a nonzero coefficient, that is the last zero coefficient in the first coefficient sequence 112 and that is a nonzero coefficient in the third coefficient sequence 218 (S202). More specifically, the pre-quantized-nonzero-coefficient non-zeroing unit 202 generates the second coefficient sequence 113 “5, 1, 1, −1, 0, 1” by converting the fourth zero coefficient of the first coefficient sequence 112 into −1.

Then, the first coefficient sequence code amount calculation unit 103 calculates the code amount 114 of the first coefficient sequence 112 (i.e., 22 bits) (S103).

The second coefficient sequence code amount calculation unit 104 calculates the code amount 115 of the second coefficient sequence 113 (i.e., 15 bits) (S104).

Then, since the code amount 115 of the second coefficient sequence 113 (i.e., 15 bits) is smaller than the code amount 114 of the first coefficient sequence 112 (i.e., 22 bits) (Yes in S105), the code amount comparison unit 105 notifies the coefficient sequence selection unit 106 to select the second coefficient sequence 113 having a smaller amount of codes. Thus, the coefficient sequence selection unit 106 outputs the second coefficient sequence 113 (5106).

Accordingly, the second coefficient sequence 113 having a smaller amount of codes than the first coefficient sequence 112 is outputted. Therefore, the amount of codes is reduced.

As explained so far, the coefficient conversion device 200 in the second embodiment of the present invention can reduce the amount of codes as is the case with the coefficient conversion device 100 described above.

Moreover, the coefficient conversion device 200 can more prevent image degradation by converting a coefficient whose value was nonzero before the quantization into a nonzero coefficient, than the case where a coefficient whose value was zero before the quantization is converted into a nonzero coefficient.

In the above example of the operation according to MPEG-2, the case of using the coding table 910 shown in FIG. 3 is described. However, the same discussion as above can be applied in the case where a different coding table according to MPEG-2 is used.

Moreover, in the above example of the operation according to H.264/AVC, the case of using the coding tables 920, 930, 940, and 950 shown in FIGS. 6 to 9 is described. However, the same discussion as above can be applied in the case where a different coding table according to H.264/AVC is used.

Furthermore, in the above description for the second embodiment, the coding methods according to MPEG-2 and H.264/AVC are used. However, the same discussion as above can be applied in the case where a coding method according to a different image coding standard is used.

Also, in the above description for the second embodiment, the second coefficient sequence 113 is generated by non-zeroing the last zero coefficient of the first coefficient sequence 112, out of the coefficients whose values were nonzero before the quantization. However, the same discussion as above can be applied in the case of non-zeroing a zero coefficient other than the last zero coefficient, out of the coefficients whose values were nonzero before the quantization. However, note that when both the level and the run are larger, the amount of codes increases more, in general. To be more specific, when the level of the original first coefficient sequence 112 is large, the run corresponding to this large level can be reduced by non-zeroing the last zero coefficient, out of the coefficients in the first coefficient sequence 112 whose values were nonzero before the quantization. Accordingly, the amount of codes can be efficiently reduced.

Moreover, in the above description for the second embodiment, a zero coefficient is converted into “1” when the corresponding pre-quantized coefficient is a positive value, and into “−1” when the corresponding pre-quantized coefficient is a negative value. However, the same discussion as above can be applied in the case where a different zeroing method is used. It should be noted that, considering that the amount of codes and a change (or, image degradation) from the original image are small when the absolute value of the level is “1” (i.e., the effect of reducing the amount of codes is large), it is preferable to convert the zero coefficient into “1” when the corresponding pre-quantized coefficient is a positive value and into “−1” when the corresponding pre-quantized coefficient is a negative value as described above.

Furthermore, in the above description for the second embodiment, the coefficient conversion device 200 generates one second coefficient sequence 113 corresponding to the first coefficient sequence 112. However, when a plurality of zero coefficients which were nonzero before the quantization are included in the first coefficient sequence 112, a plurality of second coefficient sequences 113 in which non-zeroing has been performed on different zero coefficients may be generated. In such a case, among from the first coefficient sequence 112 and the plurality of second coefficient sequences 113, a coefficient sequence having the smallest amount of codes may be outputted.

It should be noted that the order in which the processing of calculating the code amount 114 of the first coefficient sequence 112 (S103) and the processing of calculating the code amount 115 of the second coefficient sequence 113 (S104) shown in FIG. 19 are performed is arbitrary. Moreover, the processing of calculating the code amount 114 of the first coefficient sequence 112 (S103) may be performed before the processing of generating the second coefficient sequence 113 (S202) or before the processing of extracting the third coefficient sequence (S201). Furthermore, the processing of extracting the third coefficient sequence (S201) may be performed before the processing of extracting the first coefficient sequence (S101), or parts of the processing may be performed in parallel. Also, parts of the processing from step S202 to step S104 may be performed in parallel.

### Third Embodiment

The third embodiment of the present invention describes an image coding device that includes one of the coefficient conversion devices 100 and 200 explained in the above first and second embodiments respectively.

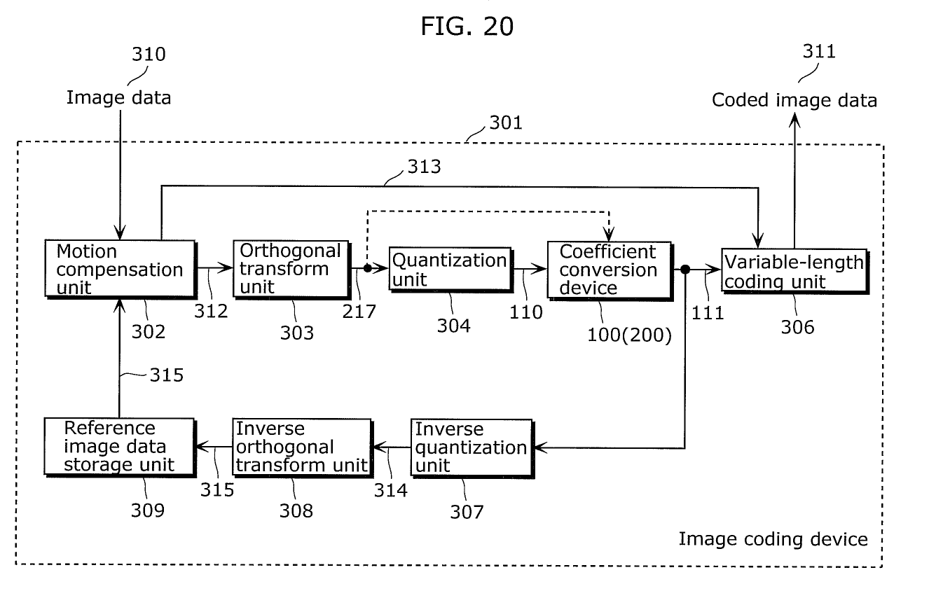

FIG. 20 is a diagram showing a configuration of an image coding device 301 that employs the coefficient conversion device 100 or 200.

The image coding device 301 shown in FIG. 20 codes received image data 310 to generate coded image data 311, and then outputs the generated coded image data 311. The image coding device 301 includes a motion compensation unit 302, an orthogonal transform unit 303, a quantization unit 304, the coefficient conversion device 100 or 200, a variable-length coding unit 306, an inverse quantization unit 307, an inverse orthogonal transform unit 308, and a reference image data storage unit 309.

The motion compensation unit 302 generates difference data 312 which represents a difference between the image data 310 and reference image data 315 stored in the reference image data storage unit 309, and then outputs the generated difference data 312 to the orthogonal transform unit 303. Moreover, the motion compensation unit 302 outputs information 313 of the reference image data 315 to the variable-length coding unit 306.

The orthogonal transform unit 303 orthogonally transforms the difference data 312 to generate orthogonal transform coefficient set 217, and then outputs the generated orthogonal transform coefficient set 217 to the quantization unit 304.

The quantization unit 304 quantizes the orthogonal transform coefficient set 217 to generate quantized coefficient set 110 which corresponds to one coded block unit, and then outputs the generated quantized coefficient set 110 to the coefficient conversion device 100 or 200.

The coefficient conversion device 100 or 200 refers to the coefficient conversion device 100 described above in the first embodiment or the coefficient conversion device 200 described above in the second embodiment. The coefficient conversion device 100 or 200 performs non-zeroing on 0 or more of zero coefficients included in the quantized coefficient set 110 to generate the post-conversion quantized coefficient set 111. Then, the coefficient conversion device 100 or 200 outputs the generated quantized coefficient set 111 to the variable-length coding unit 306 and the inverse quantization unit 307. In the case where the image coding device 301 includes the coefficient conversion device 200, the coefficient conversion device 200 converts the quantized coefficient set 110 using the pre-quantized orthogonal transform coefficient set 217 outputted from the orthogonal transform unit 303.

The inverse quantization unit 307 inversely quantizes the quantized coefficient set 111 to generate orthogonal transform coefficient set 314, and then outputs the generated orthogonal transform coefficient set 314 to the inverse orthogonal transform unit 308.

The inverse orthogonal transform unit 308 performs inverse orthogonal transform on the orthogonal transform coefficient set 314 to generate the reference image data 315, and then outputs the generated reference image data to the reference image data storage unit 309.

The reference image data storage unit 309 stores the reference image data 315 generated by the inverse orthogonal transform unit 308.

The variable-length coding unit 306 performs variable-length coding on the reference image data information 313 and the converted quantized coefficient set 111 to generate the coded image data 311. Then, the variable-length coding unit 306 outputs the generated coded image data.

With this configuration, the image coding device 301 of the present invention can code the image while reducing the amount of codes.

### Fourth Embodiment

The fourth embodiment of the present invention describes a coding rate conversion device that includes one of the coefficient conversion devices 100 and 200 explained in the above first and second embodiments respectively.

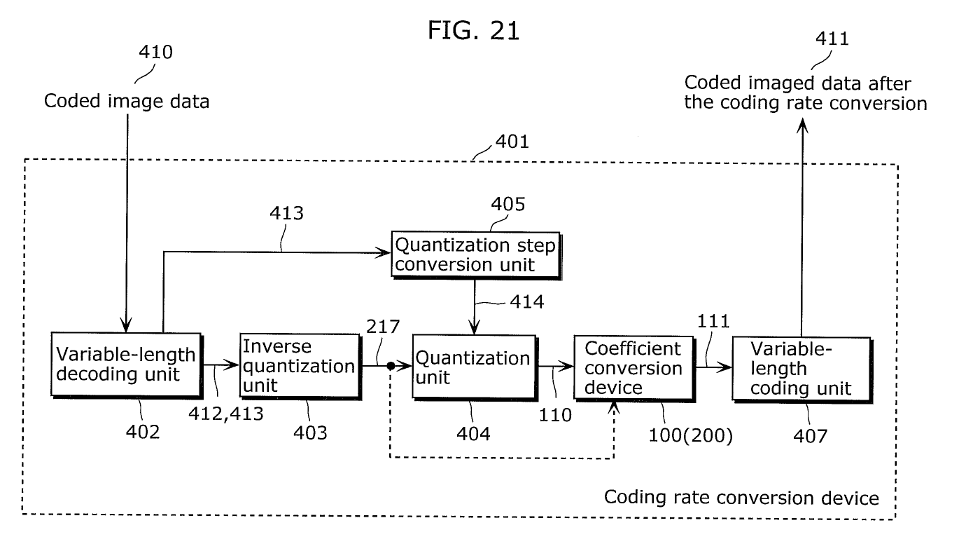

FIG. 21 is a block diagram showing a configuration of a coding rate conversion device 401 in the third embodiment of the present invention.

The coding rate conversion device 401 shown in FIG. 21 generates post-coding-rate-conversion coded image data 411 by converting a coding rate of coded image data 410 on which variable-length coding has been performed after quantization with a first quantization step. Then, the coding rate conversion device 401 outputs the generated post-coding-rate-conversion coded image data 411. To be more specific, the coding rate conversion device 401 generates the post-coding-rate-conversion coded image data 411 by decoding the coded image data 410 and then requantizing (namely, re-coding) the decoded image data 410 with a second quantization step. The coding rate conversion device 401 includes a variable-length decoding unit 402, an inverse quantization unit 403, a quantization unit 404, a quantization step conversion unit 405, the coefficient conversion device 100 or 200, and a variable-length coding unit 407.

The variable-length decoding unit 402 decodes the coded image data 410 to generate a quantized coefficient set 412 having been quantized with the first quantization step and this first quantization step 413. Moreover, the variable-length decoding unit 402 outputs the generated quantized coefficient set 412 to the inverse quantization unit 403, and outputs the first quantization step 413 to the inverse quantization unit 403 and the quantization step conversion unit 405.

The inverse quantization unit 403 inversely quantizes the quantized coefficient set 412 with the first quantization step to generate an orthogonal transform coefficient set 217, and outputs the generated orthogonal transform coefficient set 217 to the quantization unit 404.

The quantization step conversion unit 405 generates a second quantization step 414 which is larger in step size than the first quantization step 413, and then outputs the generated second quantization step 414 to the quantization unit 404.

The quantization unit 404 requantizes the orthogonal transform coefficient set 217 with the second quantization step 414 to generate a quantized coefficient set 110 that corresponds to one coded block unit. Then, the quantization unit 404 outputs the generated quantized coefficient set 110 to the coefficient conversion device 100 or 200.

The coefficient conversion device 100 or 200 refers to the coefficient conversion device 100 described above in the first embodiment or the coefficient conversion device 200 described above in the second embodiment. The coefficient conversion device 100 or 200 performs non-zeroing on 0 or more of zero coefficients included in the quantized coefficient set 110 to generate the post-conversion quantized coefficient set 111. Then, the coefficient conversion device 100 or 200 outputs the generated quantized coefficient set 111 to the variable-length coding unit 407. In the case where the coding rate conversion device 401 includes the coefficient conversion device 200, the coefficient conversion device 200 converts the quantized coefficient set 110 using the pre-quantized orthogonal transform coefficient set 217 outputted from the inverse quantization unit 403.

With this configuration, the coding rate conversion device 401 in the fourth embodiment of the present invention can reduce the amount of codes not only through the quantization step conversion but also through the non-zeroing processing.

In the above description for the fourth embodiment, the inverse quantization unit 403, the quantization step conversion unit 405, and the quantization unit 404 are separately configured. However, the same discussion as above can be applied in the case where the inverse quantization unit 403, the quantization step conversion unit 405, and the quantization unit 404 are replaced by a requantization unit that realizes inverse quantization and quantization at one time.

### Fifth Embodiment

The fifth embodiment of the present invention describes an AV stream (i.e., audio video stream) recording device that includes the image coding device 301 described in the above third embodiment.

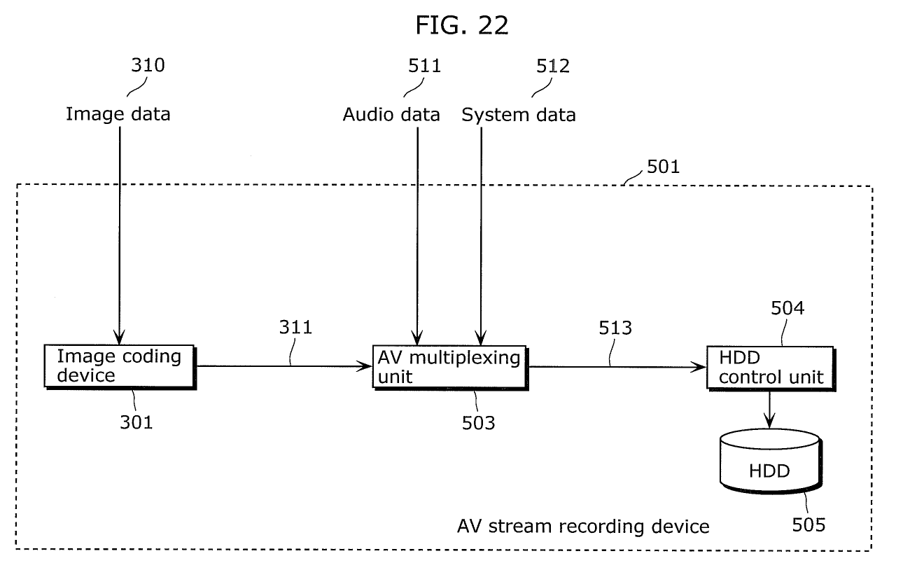

FIG. 22 is a block diagram showing a configuration of an AV stream recording device 501 in the fifth embodiment of the present invention.

The AV stream recording device 501 shown in FIG. 22 codes image data 310 and records the coded image data 310. The AV stream recording device 501 includes the image coding device 301, an AV multiplexing unit 503, an HDD control unit 504, and an HDD (Hard Disk Drive) 505.

The image coding device 301 is the same as the one described in the above third embodiment. The image coding device 301 codes the image data 310 to generate coded image data 311, and then outputs the generated coded image data 311 to the AV multiplexing unit 503.

The AV multiplexing unit 503 multiplexes the coded image data 311, audio data 511, and system data 512 to generate one AV stream 513. Then, the AV multiplexing unit 503 outputs the generated AV stream 513 to the HDD control unit 504.

The HDD control unit 504 records the AV stream 513 onto the HDD 505.

With this configuration, the AV stream recording device 501 of the present invention can reduce the HDD space requirement by the effect of the reduction in the amount of codes through the non-zeroing processing.

In the above description for the fifth embodiment, the AV stream recording device 501 records the AV stream onto the HDD 505. However, the AV stream 513 may be recorded onto a different recording medium. For example, the AV stream recording device 501 may record the AV stream 513 onto an optical disk, such as a

DVD, or into a memory card.

In the above description for the fifth embodiment, the AV stream 513 is configured by the coded image data 311, the audio data 511, and the system data 512. However, the same discussion as above can be applied in the case where other data is included in the AV stream 513.

### Sixth Embodiment

The six embodiment of the present invention describes a network distribution system that includes the image coding device 301 described in the above third embodiment.

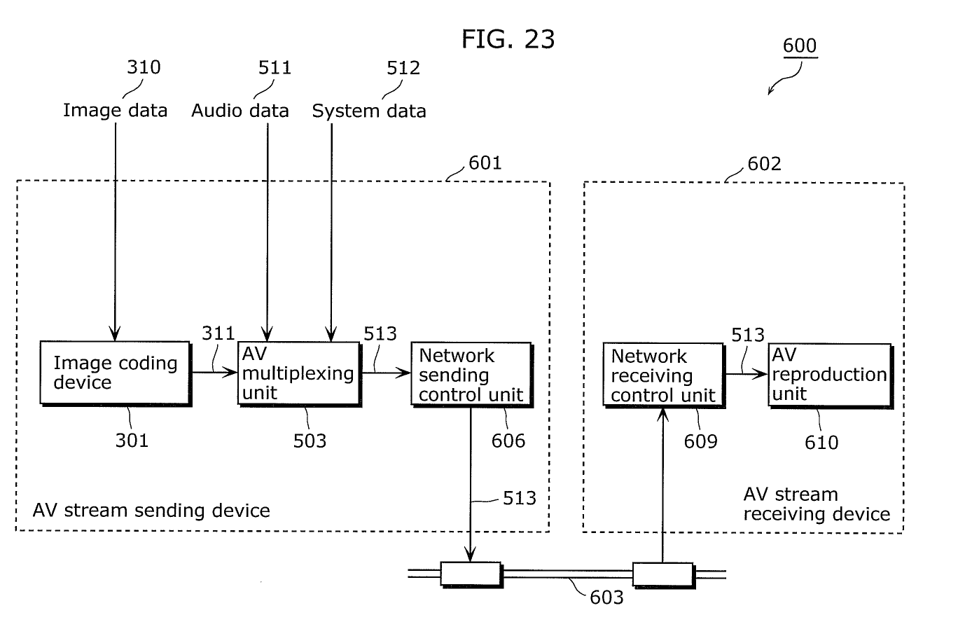

FIG. 23 is a block diagram showing a configuration of a network distribution system 600 in the sixth embodiment of the present invention. The network distribution system 600 includes an AV stream sending device 601 that sends an AV stream 513, an AV stream receiving device 602 that receives the AV stream 513, and a network 603 that transmits the AV stream 513.

The AV stream sending device 601 generates the AV stream 513 from image data 310, audio data 511, and system data 512. Then, the AV stream sending device 601 distributes the generated AV stream 513 to the AV stream receiving device 602 via the network 603.

The AV stream receiving device 602 reproduces the received AV stream 513.

The AV stream sending device 601 includes the image coding device 301, an AV multiplexing unit 503, and a network sending control unit 606.

The image coding device 301 is the same as the one described in the above third embodiment. The image coding device 301 codes the image data 310 to generate coded image data 311, and then outputs the generated coded image data 311 to the AV multiplexing unit 503.

The AV multiplexing unit 503 multiplexes the coded image data 311, audio data 511, and system data 512 to generate one AV stream 513. Then, the AV multiplexing unit 503 outputs the generated AV stream 513 to the network sending control unit 606.

The network sending control unit 606 sends the AV stream 513 to the AV stream receiving device 602 via the network 603.

The AV stream receiving device 602 includes a network receiving control unit 609 and an AV reproduction unit 610.

The network receiving control unit 609 receives the AV stream 513 sent from the AV stream sending device 601 via the network 603, and then outputs the received AV stream 513 to the AV reproduction unit 610.

The AV reproduction unit 610 first performs AV demultiplexing processing and decodes the AV stream 513. After this, the AV reproduction unit 610 reproduces the decoded audio and video. It should be noted that the AV reproduction unit 610 is not directly related to the image coding device 301 and, therefore, its detailed explanation is omitted.

With this configuration, by the effect of the reduction in the amount of codes through the non-zeroing processing, the AV stream sending device 601 in the sixth embodiment of the present invention can reduce the amount of data in the distributed AV stream 513 and the bandwidth required to send and receive the data via the network 603.

In the above description for the sixth embodiment, the AV stream 513 is configured by the coded image data 311, the audio data 511, and the system data 512. However, the same discussion as above can be applied in the case where other data is included in the AV stream 513.

### Seventh Embodiment

The seventh embodiment of the present invention describes an AV stream recording device that includes the coding rate conversion device 401 described in the above fourth embodiment.

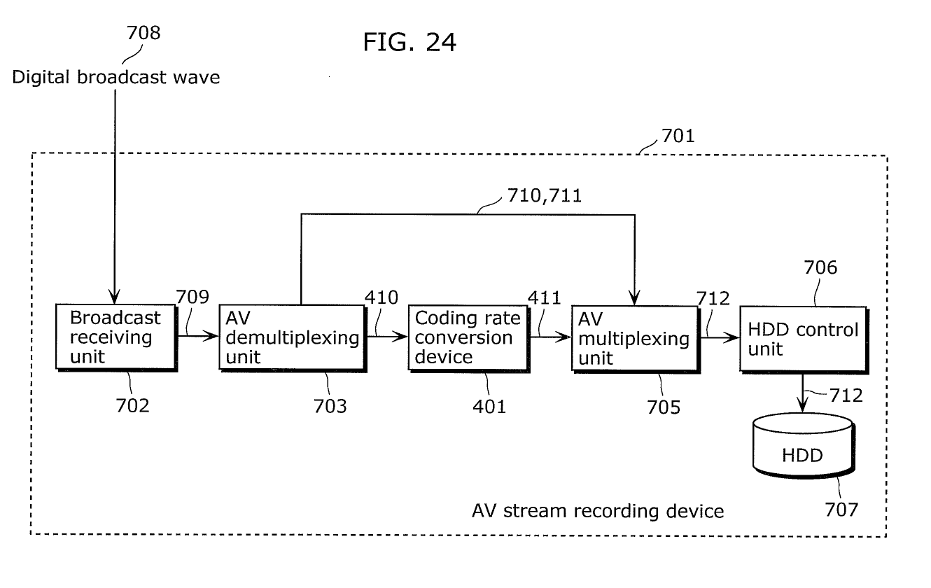

FIG. 24 is a block diagram showing a configuration of an AV stream recording device 701 in the seventh embodiment of the present invention.

The AV stream recording device 701 shown in FIG. 24 includes a broadcast receiving unit 702, an AV demultiplexing unit 703, the coding rate conversion device 401, an AV multiplexing unit 705, an HDD control unit 706, and an HDD 707. The AV stream recording device 701 receives a digital broadcast wave 708, and converts a coding rate of coded image data 410 included in an AV stream 709 of the received digital broadcast wave 708. After this, the AV stream recording device 701 records the stream onto the HDD 707.

A plurality of AV streams are multiplexed and modulated in the digital broadcast wave 708 which is then transmitted on a carrier wave. Coded image data, audio data, and system data are multiplexed in the plurality of AV streams.

The broadcast receiving unit 702 demodulates the digital broadcast wave 708 to generate the plurality of AV streams. Then, the broadcast receiving unit 702 separates one desired AV stream 709 from the plurality of AV streams. Moreover, the broadcast receiving unit 702 outputs the separated AV stream 709 to the AV demultiplexing unit 703.

The AV demultiplexing unit 703 separates coded image data 410, audio data 710, and system data 711 from the AV stream 709. Also, the AV demultiplexing unit 703 outputs the coded image data 410 to the coding rate conversion device 401 as well as outputting the audio data 710 and the system data 711 to the AV multiplexing unit 705.

The coding rate conversion device 401 is the same as the one described in the above fourth embodiment. The coding rate conversion device 401 converts a coding rate of the coded image data 410 to a desired coding rate to generate post-coding-rate-conversion coded image data 411. Then, the coding rate conversion device 401 outputs the generated post-coding-rate-conversion coded image data 411 to the AV multiplexing unit 705.

The AV multiplexing unit 705 multiplexes the post-coding-rate-conversion coded image data 411, the original audio data 710, and the original system data 711 to reconstruct one AV stream 712. Then, the AV multiplexing unit 705 outputs the reconstructed AV stream 712 to the HDD control unit 706.

The HDD control unit 706 records the AV stream 712 onto the HDD 707.

With this configuration, the AV stream recording device 701 of the present invention can reduce the HDD 707 space requirement by the effect of the reduction in the amount of codes through the non-zeroing processing.

In the above description for the seventh embodiment, the AV stream recording device 701 receives the digital broadcast wave 708. However, the AV stream recording device 701 may receive an AV stream which has been recorded onto an HDD without the coding rate conversion, or an AV stream distributed via a network.

In the above description for the seventh embodiment, the AV stream recording device 701 records the AV stream 712 onto the HDD 707. However, the AV stream 712 may be recorded onto a different recording medium. For example, the AV stream recording device 701 may record the AV stream 712 onto an optical disk, such as a DVD, or into a memory card.

In the above description for the seventh embodiment, each of the AV streams 709 and 712 is configured by the coded image data, the audio data, and the system data. However, the same discussion as above can be applied in the case where other data is included in the AV stream.

### Eighth Embodiment

The eighth embodiment of the present invention describes a network distribution system that includes the coding rate conversion device 401 described in the above fourth embodiment.

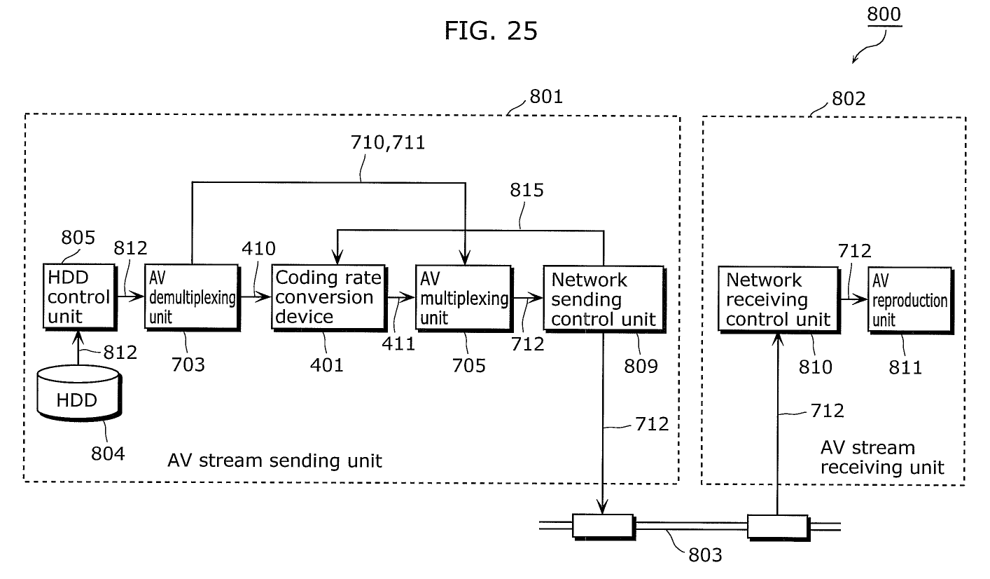

FIG. 25 is a block diagram showing a configuration of a network distribution system 800 in the eighth embodiment of the present invention.

The network distribution system 800 shown in FIG. 25 includes an AV stream sending device 801 that sends an AV stream, an AV stream receiving device 802 that receives the AV stream, and a network 803 that transmits the AV stream. The AV stream sending device 801 distributes the AV stream recorded onto an HDD 804 to the AV stream receiving device via the network 803. The AV stream receiving device 802 reproduces the received AV stream.

The AV stream sending device 801 includes the HDD 804, an HDD control unit 805, an AV demultiplexing unit 703, the coding rate conversion device 401, an AV multiplexing unit 705, and a network sending control unit 809.

An AV stream 812 is stored in the HDD 804.

The HDD control unit 805 reads the AV stream 812 from the HDD 804, and outputs the read AV stream 812 to the AV demultiplexing unit 703.

The AV demultiplexing unit 703 separates coded image data 410, audio data 710, and system data 711 from the AV stream 812. Moreover, the AV demultiplexing unit 703 outputs the coded image data 410 to the coding rate conversion device 401 as well as outputting the audio data 710 and the system data 711 to the AV multiplexing unit 705.

The coding rate conversion device 401 is the same as the one described in the above fourth embodiment. The coding rate conversion device 401 converts a coding rate of the coded image data 410 to a coding rate 815 outputted from the network sending control unit 809, so as to generate post-coding-rate-conversion coded image data 411. Then, the coding rate conversion device 401 outputs the generated post-coding-rate-conversion coded image data 411 to the AV multiplexing unit 705.

The AV multiplexing unit 705 multiplexes the post-coding-rate-conversion coded image data 411, the original audio data 710, and the original system data 711 to reconstruct one AV stream 712. Then, the AV multiplexing unit 705 outputs the reconstructed AV stream 712 to the network sending control unit 809.

The network sending control unit 809 sends the AV stream 712 to the AV stream receiving device 802 via the network 803. Moreover, the network sending control unit 809 detects the coding rate 815 at which the re-multiplexed AV stream 712 can be sent to the AV stream receiving device 802 via the network 803, and then outputs the detected coding rate 815 to the coding rate conversion device 401.

The AV stream receiving device 802 includes a network receiving control unit 810 and an AV reproduction unit 811.

The network receiving control unit 810 receives the AV stream 712 sent from the AV stream sending device 801 via the network 803, and then outputs the received AV stream 712 to the AV reproduction unit 811.

The AV reproduction unit 811 first performs AV demultiplexing processing and decodes the AV stream 712. After this, the AV reproduction unit 811 reproduces the decoded audio and video. It should be noted that the AV reproduction unit 811 is not directly related to the coding rate conversion device 401 and, therefore, its detailed explanation is omitted.

With this configuration, by the effect of the reduction in the amount of codes through the non-zeroing processing, the AV stream sending device 801 in the present invention can reduce the amount of data in the distributed AV stream 712. Accordingly, the AV stream sending device 801 can reduce the bandwidth required to send and receive the data via the network.

In the above description for the eight embodiment, the AV stream sending device 801 converts the coding rate of the AV stream 812 stored in the HDD 804. However, the the AV stream sending device 801 may convert a coding rate of the digital broadcast wave itself or of an AV stream recorded in a different recording medium.

In the above description for the eighth embodiment, each of the AV streams 812 and 712 is configured by the coded image data 410, the audio data 710, and the system data. However, the same discussion as above can be applied in the case where other data is included in the AV stream.

The processing units included in the coefficient conversion devices 100 and 200, the image coding device 301, the coding rate conversion device 401, the AV stream recording devices 501 and 701, and the AV stream sending device 601 and 801 in the above first to eighth embodiments are typically implemented as LSIs which are integrated circuits. These LSIs may be integrated into individual chips, or into a single chip so as to include some or all of the LSIs.

Although referred to as the LSI here, it may be referred to as an IC, a system LSI, a super LSI, or an ultra LSI depending on the degree of integration.

Moreover, the implemented integrated circuit is not limited to an LSI, and may be realized using a dedicated circuit or a general purpose processor. Also, an FPGA (Field Programmable Gate Array) which is programmable after the manufacture of the LSI, or a reconfigurable processor for which the connections and settings of circuit cells inside the LSI are reconfigurable may be used.

Furthermore, when a circuit integration technology that replaces LSIs comes along owing to advances of the semiconductor technology or to a derived technology, the processing units should be understandably integrated using that technology. As a possibility, application of biotechnology can be considered, for example.

Some or all of the functions of the coefficient conversion devices 100 and 200, the image coding device 301, the coding rate conversion device 401, the AV stream recording devices 501 and 701, the AV stream sending device 601 and 801, and the AV stream receiving devices 602 and 802 in the above first to eighth embodiments of the present invention may be implemented by causing a processor, such as a CPU, to execute programs.

Also, the present invention may be the programs, and may be recording media on which the programs are recorded.

Moreover, at least some of the functions of the coefficient conversion devices 100 and 200, the image coding device 301, the coding rate conversion device 401, the AV stream recording devices 501 and 701, and the AV stream sending device 601 and 801 in the above first to eighth embodiments may be combined.

### INDUSTRIAL APPLICABILITY

The present invention is applicable to a coefficient conversion device, an image coding device, and the coding rate conversion device. In particular, the present invention is applicable to an AV stream recording device and an AV stream sending device.

1. An image coding device comprising:
a quantization unit configured to quantize an orthogonal transform coefficient set obtained by orthogonally transforming image data, so as to generate a quantized coefficient set that corresponds to one coded block unit;
a coefficient sequence extraction unit configured to extract a first coefficient sequence which is a part of the quantized coefficient set;
a coefficient non-zeroing unit configured to convert at least one of zero coefficients included in the first coefficient sequence into a nonzero coefficient, so as to generate a second coefficient sequence including all coefficients resulting from the conversion;
a coefficient sequence selection unit configured to select one of the first coefficient sequence and the second coefficient sequence, the selected one having a smaller amount of codes when coded; and
a variable-length coding unit configured to perform variable-length coding on the one of the first coefficient sequence and the second coefficient sequence selected by said coefficient sequence selection unit, so as to generate coded image data.

2. The image coding device according to claim 1,
wherein said coefficient sequence extraction unit is configured to sequentially extract a plurality of first coefficient sequences from the quantized coefficient set,
said coefficient non-zeroing unit is configured to generate the second coefficient sequence for each of the first coefficient sequences extracted by said coefficient sequence extraction unit, and
said coefficient sequence selection unit is configured to make a selection, for each of the first coefficient sequences, between the first coefficient sequence and the second coefficient sequence corresponding to the first coefficient sequence, the selected first or second coefficient sequence having a smaller amount of codes when coded.

3. The image coding device according to claim 2,
wherein said coefficient sequence extraction unit is configured to extract, as the first coefficient sequence, consecutive zero coefficients and one nonzero coefficient that follows the consecutive zero coefficients, from a coefficient sequence in which all coefficients included in the quantized coefficient set are arranged in a scanning order.

4. The image coding device according to claim 3,
wherein said coefficient non-zeroing unit is configured to convert a zero coefficient out of the zero coefficients included in the first coefficient sequence into a nonzero coefficient, the zero coefficient having been a nonzero coefficient before the quantization.

5. The image coding device according to claim 4,
wherein said coefficient non-zeroing unit is configured to convert the zero coefficient into: 1 when the zero coefficient that is to be converted into the nonzero coefficient is a positive-value coefficient before the quantization; and −1 when the zero coefficient that is to be converted into the nonzero coefficient is a negative-value coefficient before the quantization.

6. The image coding device according to claim 3,
wherein said coefficient non-zeroing unit is configured to convert a last zero coefficient included in the first coefficient sequence into a nonzero coefficient, so as to generate the second coefficient sequence.

7. The image coding device according to claim 2,
wherein said coefficient non-zeroing unit is configured to convert at least one of the zero coefficients included in the first coefficient sequence into 1, so as to generate the second coefficient sequence.

8. The image coding device according to claim 2,
wherein said coefficient non-zeroing unit is configured to convert at least one of the zero coefficients included in the first coefficient sequence into −1, so as to generate the second coefficient sequence.

9. The image coding device according to claim 1,
wherein said coefficient sequence extraction unit is configured to extract, from a coefficient sequence in which all coefficients included in the quantized coefficient set are arranged in a scanning order, a sequence from a beginning to a last nonzero coefficient of the coefficient sequence as the first coefficient sequence.

10-14. (canceled)

15. A coefficient conversion device which converts a quantized coefficient set corresponding to one coded block unit obtained by orthogonally transforming and quantizing image data, into a quantized coefficient set on which variable-length coding is to be performed, said coefficient conversion device comprising:
a coefficient sequence extraction unit configured to extract a first coefficient sequence which is a part of the quantized coefficient set;
a coefficient non-zeroing unit configured to convert at least one of zero coefficients included in the first coefficient sequence into a nonzero coefficient, so as to generate a second coefficient sequence including all coefficients resulting from the conversion; and
a coefficient sequence selection unit configured to select one of the first coefficient sequence and the second coefficient sequence as the quantized coefficient set on which variable-length coding is to be performed, the selected one having a smaller amount of codes when coded.

16. An integrated circuit comprising:
a quantization unit configured to quantize an orthogonal transform coefficient set obtained by orthogonally transforming image data, so as to generate a quantized coefficient set that corresponds to one coded block unit;
a coefficient sequence extraction unit configured to extract a first coefficient sequence which is a part of the quantized coefficient set;
a coefficient non-zeroing unit configured to convert at least one of zero coefficients included in the first coefficient sequence into a nonzero coefficient, so as to generate a second coefficient sequence including all coefficients resulting from the conversion;
a coefficient sequence selection unit configured to select one of the first coefficient sequence and the second coefficient sequence, the selected one having a smaller amount of codes when coded; and
a variable-length coding unit configured to perform variable-length coding on the one of the first coefficient sequence and the second coefficient sequence selected by said coefficient sequence selection unit, so as to generate coded image data.

17. An image coding method comprising:
quantizing an orthogonal transform coefficient set obtained by orthogonally transforming image data, so as to generate a quantized coefficient set that corresponds to one coded block unit;
extracting a first coefficient sequence which is a part of the quantized coefficient set;
converting at least one of zero coefficients included in the first coefficient sequence into a nonzero coefficient, so as to generate a second coefficient sequence including all coefficients resulting from the conversion;
selecting one of the first coefficient sequence and the second coefficient sequence, the selected one having a smaller amount of codes when coded; and
performing variable-length coding on the first coefficient sequence or the second coefficient sequence selected by the coefficient sequence selection unit, so as to generate coded image data.
